(19) United States
(12) Patent Application Publication
(10) Pub. No.: US 2025/0261170 A1
(43) Pub. Date: Aug. 14, 2025

(54) RADIO FREQUENCY ENERGY HARVESTING CONFIGURATION

(71) Applicant: QUALCOMM INCORPORATED, San Diego, CA (US)

(72) Inventors: Ahmed Elshafie, San Diego, CA (US); Yuchul Kim, San Diego, CA (US); Zhikun Wu, Beijing (CN); Linhai He, San Diego, CA (US); Huilin Xu, Temecula, CA (US); Peter Gaal, San Diego, CA (US); Wanshi Chen, San Diego, CA (US); Krishna Kiran Mukkavilli, San Diego, CA (US); Tingfang Ji, San Diego, CA (US)

(21) Appl. No.: 18/859,132

(22) PCT Filed: Jun. 14, 2022
(86) PCT No.: PCT/CN2022/098574

§ 371 Date: Oct. 22, 2024

(51) Int. Cl. H04W 72/044; H02J 50/00; H02J 50/20; H02J 50/80; H04L 5/00; H04W 52/02

(52) U.S. Cl. CPC H04W 72/044; H02J 50/001; H02J 50/20; H02J 50/80; H04L 5/0051; H04W 52/0261

(57) ABSTRACT

Methods, systems, and devices for wireless communications are described. A user equipment (UE) may perform event-based energy harvesting reporting to a network entity providing a signal for wireless charging or powering of the UE. The UE may signal its energy harvesting-related capabilities. and the network entity may signal to the UE a configuration for energy harvesting and event-based energy harvesting reporting. The configuration may include an indication of an energy harvesting charging range of the network entity. In some examples, the UE may indicate a maximum battery capacity of the UE, so that the network entity may determine to stop charging when the battery capacity is reached. The UE may be configured to report energy harvesting procedures according to triggering events, such as battery level of the UE or a switch in bandwidth or frequency of a charging signal.

### CROSS REFERENCE

The present Application is a 371 national stage filing of International PCT Application No. PCT/CN2022/098574 by Elshafie et al. entitled “RADIO FREQUENCY ENERGY HARVESTING CONFIGURATION,” filed Jun. 14, 2022, which is assigned to the assignee hereof, and which is expressly incorporated by reference in its entirety herein.

### TECHNICAL FIELD

The following relates to wireless communications, including radio frequency energy harvesting configuration.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-a Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A UE may support energy harvesting procedures or processes to harvest energy for operation from various sources. For example, the UE may harvest energy from solar, vibrational, thermal, and radio frequency (RF) sources.

### SUMMARY

The described techniques relate to improved methods, systems, devices, and apparatuses that support a radio frequency energy harvesting configuration. For example, the described techniques provide for a user equipment (UE) performing event-based energy harvesting reporting to a network entity providing a signal (e.g., a radio frequency (RF) signal) for wireless charging or powering of the UE. The UE may signal its energy harvesting-related capabilities, and the network entity may signal to the UE a configuration for energy harvesting and event-based energy harvesting reporting. For example, the UE may report a capability indicating a relationship between an efficiency of an energy harvesting circuit of the UE and various parameters, such as bandwidth, input power, frequency, waveform, modulation, or other parameters. In some examples, the UE may indicate a battery capacity (e.g., a maximum battery capacity) of the UE, so that the network entity may determine to stop charging when the battery capacity is reached. The UE may be configured to report energy status messages, such as a battery level satisfying (e.g., being above or below) a threshold, or a current battery level. In some cases, the UE may request a change in bandwidth or frequency of the charging RF signal. In some examples, the network entity may limit charging to devices located nearby (e.g., within a charging area). The network entity may communicate a distance range and, in some cases, an indication of whether a particular device is within the range.

A method for wireless communications at a user equipment UE is described. The method may include transmitting an indication of a capability to support radio frequency energy harvesting at the UE, receiving control signaling indicating an energy harvesting configuration based on the indication of the capability, receiving, on a radio frequency spectrum band, a signal for the radio frequency energy harvesting to charge the UE based on the energy harvesting configuration, and transmitting an energy harvesting report based on the energy harvesting configuration.

An apparatus for wireless communications at a UE is described. The apparatus may include a processor, memory coupled with the processor, and instructions stored in the memory. The instructions may be executable by the processor to cause the apparatus to transmit an indication of a capability to support radio frequency energy harvesting at the UE, receive control signaling indicating an energy harvesting configuration based on the indication of the capability, receive, on a radio frequency spectrum band, a signal for the radio frequency energy harvesting to charge the UE based on the energy harvesting configuration, and transmit an energy harvesting report based on the energy harvesting configuration.

Another apparatus for wireless communications at a UE is described. The apparatus may include means for transmitting an indication of a capability to support radio frequency energy harvesting at the UE, means for receiving control signaling indicating an energy harvesting configuration based on the indication of the capability, means for receiving, on a radio frequency spectrum band, a signal for the radio frequency energy harvesting to charge the UE based on the energy harvesting configuration, and means for transmitting an energy harvesting report based on the energy harvesting configuration.

A non-transitory computer-readable medium storing code for wireless communications at a UE is described. The code may include instructions executable by a processor to transmit an indication of a capability to support radio frequency energy harvesting at the UE, receive control signaling indicating an energy harvesting configuration based on the indication of the capability, receive, on a radio frequency spectrum band, a signal for the radio frequency energy harvesting to charge the UE based on the energy harvesting configuration, and transmit an energy harvesting report based on the energy harvesting configuration.

In some examples of the method, apparatuses, and non-transitory computer-readable medium described herein, receiving the control signaling may include operations, features, means, or instructions for receiving the control signaling indicating a resource allocation for the radio frequency spectrum band.

In some examples of the method, apparatuses, and non-transitory computer-readable medium described herein, transmitting the indication of the capability may include operations, features, means, or instructions for transmitting an indication of a charging storage capacity of the UE, where the signal for the radio frequency energy harvesting may be received for a duration that may be based on the charging storage capacity of the UE.

In some examples of the method, apparatuses, and non-transitory computer-readable medium described herein, transmitting the energy harvesting report may include operations, features, means, or instructions for transmitting an indication that a battery of the UE satisfies a charge threshold based on receiving the signal for the radio frequency energy harvesting.

In some examples of the method, apparatuses, and non-transitory computer-readable medium described herein, transmitting the energy harvesting report may include operations, features, means, or instructions for transmitting the energy harvesting report based on detecting a trigger to transmit the energy harvesting report corresponding to a battery level for a battery of the UE, a change to the battery level for the battery, a change to a radio frequency spectrum band of the signal for the radio frequency energy harvesting, or any combination thereof.

Some examples of the method, apparatuses, and non-transitory computer-readable medium described herein may further include operations, features, means, or instructions for reselecting to a second radio frequency spectrum band to receive the signal for the radio frequency energy harvesting, where energy harvesting report may be transmitted on the radio frequency spectrum band or the second radio frequency spectrum band.

In some examples of the method, apparatuses, and non-transitory computer-readable medium described herein, transmitting the energy harvesting report may include operations, features, means, or instructions for transmitting an indication of a charging rate for a battery of the UE based on the radio frequency energy harvesting, a duration until the battery may be charged at least a threshold amount, a duration until the battery may be charged to support communication, a requested charging rate, or any combination thereof.

In some examples of the method, apparatuses, and non-transitory computer-readable medium described herein, receiving the control signaling may include operations, features, means, or instructions for receiving an indication of a coverage range of the signal for the radio frequency energy harvesting.

Some examples of the method, apparatuses, and non-transitory computer-readable medium described herein may further include operations, features, means, or instructions for receiving an indication that a position of the UE may be within the coverage range of the signal, where the signal may be received based on the indication that the position of the UE may be within the coverage range of the signal.

Some examples of the method, apparatuses, and non-transitory computer-readable medium described herein may further include operations, features, means, or instructions for receiving a reference signal to determine a position of the UE may be within the coverage range of the signal and transmitting an indication that the position of the UE may be within the coverage range of the signal, where the signal may be received based on the indication that the position of the UE may be within the coverage range of the signal.

Some examples of the method, apparatuses, and non-transitory computer-readable medium described herein may further include operations, features, means, or instructions for receiving an indication of one or more classes of UEs that may be supported for the radio frequency energy harvesting within the coverage range of the signal, that may be supported during a time duration, that may be supported until an indicated time, that may be supported at a current time, or any combination thereof.

In some examples of the method, apparatuses, and non-transitory computer-readable medium described herein, transmitting the indication of the capability may include operations, features, means, or instructions for transmitting an indication of a relationship between an output of an energy harvesting circuit of the UE and an input power to the energy harvesting circuit, a frequency of the signal for the radio frequency energy harvesting, a waveform of the signal for the radio frequency energy harvesting, a modulation of the signal for the radio frequency energy harvesting, or any combination thereof.

Some examples of the method, apparatuses, and non-transitory computer-readable medium described herein may further include operations, features, means, or instructions for monitoring for a data signal on the radio frequency spectrum band after a switching duration between the signal for the radio frequency energy harvesting and the data signal.

Some examples of the method, apparatuses, and non-transitory computer-readable medium described herein may further include operations, features, means, or instructions for selecting one or more rectifier circuits for the radio frequency energy harvesting based on an input power from the signal.

In some examples of the method, apparatuses, and non-transitory computer-readable medium described herein, a first set of one or more rectifier circuits may be associated with a first frequency configuration of a set of frequency configurations, and a second set of one or more rectifier circuits may be associated with a second frequency configuration of the set of frequency configurations.

In some examples of the method, apparatuses, and non-transitory computer-readable medium described herein, the one or more rectifier circuits may be selected based on a radio access technology of the signal or the radio frequency spectrum band, or both.

In some examples of the method, apparatuses, and non-transitory computer-readable medium described herein, transmitting the indication of the capability may include operations, features, means, or instructions for transmitting an indication of a capability for the UE to hold energy based on the radio frequency energy harvesting.

In some examples of the method, apparatuses, and non-transitory computer-readable medium described herein, transmitting the indication of the capability may include operations, features, means, or instructions for transmitting an indication of a class of the UE, where the class of the UE indicates whether the UE may be capable of holding energy.

In some examples of the method, apparatuses, and non-transitory computer-readable medium described herein, the energy harvesting report includes an indication of a class of the UE.

A method for wireless communications at a network entity is described. The method may include receiving an indication of a capability for a UE to support radio frequency energy harvesting at the UE, transmitting control signaling indicating an energy harvesting configuration based on the capability, transmitting, on a radio frequency spectrum band, a signal for the radio frequency energy harvesting to charge the UE based on the energy harvesting configuration, and receiving an energy harvesting report based on the energy harvesting configuration.

An apparatus for wireless communications at a network entity is described. The apparatus may include a processor, memory coupled with the processor, and instructions stored in the memory. The instructions may be executable by the processor to cause the apparatus to receive an indication of a capability for a UE to support radio frequency energy harvesting at the UE, transmit control signaling indicating an energy harvesting configuration based on the capability, transmit, on a radio frequency spectrum band, a signal for the radio frequency energy harvesting to charge the UE based on the energy harvesting configuration, and receive an energy harvesting report based on the energy harvesting configuration.

Another apparatus for wireless communications at a network entity is described. The apparatus may include means for receiving an indication of a capability for a UE to support radio frequency energy harvesting at the UE, means for transmitting control signaling indicating an energy harvesting configuration based on the capability, means for transmitting, on a radio frequency spectrum band, a signal for the radio frequency energy harvesting to charge the UE based on the energy harvesting configuration, and means for receiving an energy harvesting report based on the energy harvesting configuration.

A non-transitory computer-readable medium storing code for wireless communications at a network entity is described. The code may include instructions executable by a processor to receive an indication of a capability for a UE to support radio frequency energy harvesting at the UE, transmit control signaling indicating an energy harvesting configuration based on the capability, transmit, on a radio frequency spectrum band, a signal for the radio frequency energy harvesting to charge the UE based on the energy harvesting configuration, and receive an energy harvesting report based on the energy harvesting configuration.

In some examples of the method, apparatuses, and non-transitory computer-readable medium described herein, transmitting the control signaling may include operations, features, means, or instructions for transmitting the control signaling indicating a resource allocation for the radio frequency spectrum band.

In some examples of the method, apparatuses, and non-transitory computer-readable medium described herein, receiving the indication of the capability may include operations, features, means, or instructions for receiving an indication of a charging storage capacity of the UE, where the signal for the radio frequency energy harvesting may be received for a duration that may be based on the charging storage capacity of the UE.

In some examples of the method, apparatuses, and non-transitory computer-readable medium described herein, receiving the energy harvesting report may include operations, features, means, or instructions for receiving an indication that a battery of the UE satisfies a charge threshold based on receiving the signal for the radio frequency energy harvesting.

In some examples of the method, apparatuses, and non-transitory computer-readable medium described herein, receiving the energy harvesting report may include operations, features, means, or instructions for receiving an indication of a charging rate for a battery of the UE based on the radio frequency energy harvesting, a duration until the battery may be charged at least a threshold amount, a duration until the battery may be charged to support communication, a requested charging rate, or any combination thereof.

In some examples of the method, apparatuses, and non-transitory computer-readable medium described herein, transmitting the control signaling may include operations, features, means, or instructions for transmitting an indication of a coverage range of the signal for the radio frequency energy harvesting.

Some examples of the method, apparatuses, and non-transitory computer-readable medium described herein may further include operations, features, means, or instructions for transmitting or receiving an indication that a position of the UE may be within the coverage range of the signal, where the signal may be transmitted based on the indication that the position of the UE may be within the coverage range of the signal.

In some examples of the method, apparatuses, and non-transitory computer-readable medium described herein, receiving the indication of the capability may include operations, features, means, or instructions for receiving an indication of a relationship between an output of an energy harvesting circuit of the UE and an input power to the energy harvesting circuit, a frequency of the signal for the radio frequency energy harvesting, a waveform of the signal for the radio frequency energy harvesting, a modulation of the signal for the radio frequency energy harvesting, or any combination thereof.

Some examples of the method, apparatuses, and non-transitory computer-readable medium described herein may further include operations, features, means, or instructions for transmitting a data signal on the radio frequency spectrum band after a switching duration between the signal for the radio frequency energy harvesting and the data signal.

### BRIEF DESCRIPTION OF THE DRAWINGS

FIG. 1 illustrates an example of a wireless communications system that supports radio frequency energy harvesting configuration in accordance with one or more aspects of the present disclosure.

FIG. 2 illustrates an example of a wireless communications system that supports radio frequency energy harvesting configuration in accordance with one or more aspects of the present disclosure.

FIG. 3 illustrates an example of a configuration diagram that supports radio frequency energy harvesting configuration in accordance with one or more aspects of the present disclosure.

FIG. 4 illustrates an example of a signaling diagram that supports radio frequency energy harvesting configuration in accordance with one or more aspects of the present disclosure.

FIG. 5 illustrates an example of a process flow that supports radio frequency energy harvesting configuration in accordance with one or more aspects of the present disclosure.

FIGS. 6 and 7 show block diagrams of devices that support radio frequency energy harvesting configuration in accordance with one or more aspects of the present disclosure.

FIG. 8 shows a block diagram of a communications manager that supports radio frequency energy harvesting configuration in accordance with one or more aspects of the present disclosure.

FIG. 9 shows a diagram of a system including a device that supports radio frequency energy harvesting configuration in accordance with one or more aspects of the present disclosure.

FIGS. 10 and 11 show block diagrams of devices that support radio frequency energy harvesting configuration in accordance with one or more aspects of the present disclosure.

FIG. 12 shows a block diagram of a communications manager that supports radio frequency energy harvesting configuration in accordance with one or more aspects of the present disclosure.

FIG. 13 shows a diagram of a system including a device that supports radio frequency energy harvesting configuration in accordance with one or more aspects of the present disclosure.

FIGS. 14 and 15 show flowcharts illustrating methods that support radio frequency energy harvesting configuration in accordance with one or more aspects of the present disclosure.

### DETAILED DESCRIPTION

Some wireless communication systems may support energy harvesting procedures or processes by a user equipment (UE) from a radio frequency (RF) source. For example, a UE may support energy harvesting from an RF source using one or more antennas and rectifier circuits to power components or a battery of the UE. In some cases, the UE supporting energy harvesting procedures from an RF source may have an efficiency corresponding to an energy harvesting circuit (e.g., a rectifier circuit) that is based on the bandwidth used as a radiofrequency source and other parameters. However, some systems do not support communicating energy harvesting signaling to a network entity providing the RF source. For example, a UE may be unable to communicate the relationship between the energy harvesting circuit efficiency and the bandwidth or other parameters, resulting in a relatively inefficient bandwidth or configuration being used for energy harvesting by the network entity and the UE. Additionally, the UE may be unable to signal the network entity that a battery of the UE is at capacity, resulting in inefficient power utilization as the network entity continues to transmit the RF source.

According to one or more aspects of the present disclosure, the UE may perform event-based energy harvesting reporting to a network entity providing a signal (e.g., an RF signal) for wireless charging or powering of the UE. The UE may indicate energy harvesting-related capabilities of the UE, and the network entity may indicate a configuration for energy harvesting and event-based energy harvesting reporting to the UE. For example, the UE may report a capability indicating a relationship between an efficiency of an energy harvesting circuit of the UE and various parameters, such as bandwidth, input power, frequency, waveform, modulation, or other parameters. In some examples, the UE may indicate a battery capacity (e.g., a maximum battery capacity) of the UE, so that the network entity may determine to stop charging when the battery capacity is reached. The UE may be configured to report energy status messages, such as a battery level satisfying (e.g., being above or below) a threshold, or a current battery level. In some cases, the UE may request a change in bandwidth or frequency of the charging RF signal. In some examples, the network entity may limit charging to devices located nearby (e.g., within a charging area). The network entity may communicate a distance range and, in some cases, an indication of whether a particular device is within the range.

Aspects of the disclosure are initially described in the context of wireless communications systems. Aspects of the disclosure are additionally described in the context of configuration and signaling diagrams. Aspects of the disclosure are further illustrated by and described with reference to apparatus diagrams, system diagrams, and flowcharts that relate to radio frequency energy harvesting configuration.

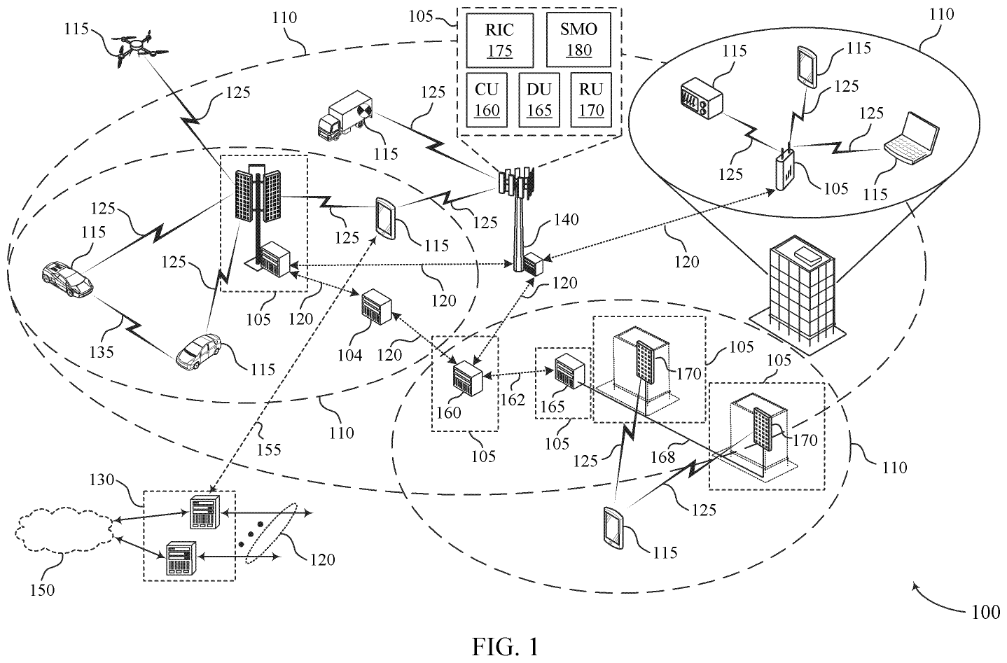

FIG. 1 illustrates an example of a wireless communications system 100 that supports radio frequency energy harvesting configuration in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-a Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., an RF access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, or computing system, may include disclosure of the UE 115, network entity 105, apparatus, device, or computing system being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support radio frequency energy harvesting configuration as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), an RFID tag, a tablet computer, a laptop computer, a personal computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-a, LTE-a Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some implementations according to aspects of the present disclosure, the wireless communications system 100 may support a UE 115 may performing event-based energy harvesting reporting to a network entity providing a signal (e.g., an RF signal) for wireless charging or powering of the UE 115. In some cases, the UE 115 may be an example of a passive IoT device (e.g., passive without a battery, passive with a super capacitor, or semi-passive with a battery), and may be used for identification, tracking, sensing, or other purposes. The UE 115 may perform energy harvesting procedures using an energy harvester (e.g., for RF), which may comprise one or more components such as antennas, impedance matching networks, voltage multipliers, capacitors, and other components. The voltage multiplier may include one or more diodes in a rectifying circuit, which may convert received signals from alternating current into direct current voltage. The energy harvesting procedures may avoid repeated charging of the UE 115 through a physical power outlet, reduce the number of battery replacements, and allow functioning of the UE 115 in conditions not well suited for a battery, such as extreme environmental conditions, high humidity, vibrations, or pressure, and other conditions.

The UE 115 may signal its energy harvesting-related capabilities, and the network entity 105 may signal to the UE 115 a configuration for energy harvesting and event-based energy harvesting reporting. For example, the UE 115 may report a capability indicating a relationship between an efficiency of an energy harvesting circuit of the UE 115 and various parameters, such as bandwidth, input power, frequency, waveform, modulation, or other parameters. In some examples, the UE 115 may indicate a maximum battery capacity of the UE 115, so that the network entity 105 may determine to stop charging when the battery capacity is reached. The UE 115 may be configured to report energy status messages, such as a battery level satisfying (e.g., being above or below) a threshold, or a current battery level. In some cases, the UE 115 may request a change in bandwidth or frequency of the charging RF signal. In some examples, the network entity 105 may limit charging to devices located nearby (e.g., within a charging area). The network entity 105 may communicate a distance range and, in some cases, an indication of whether a particular device is within the range.

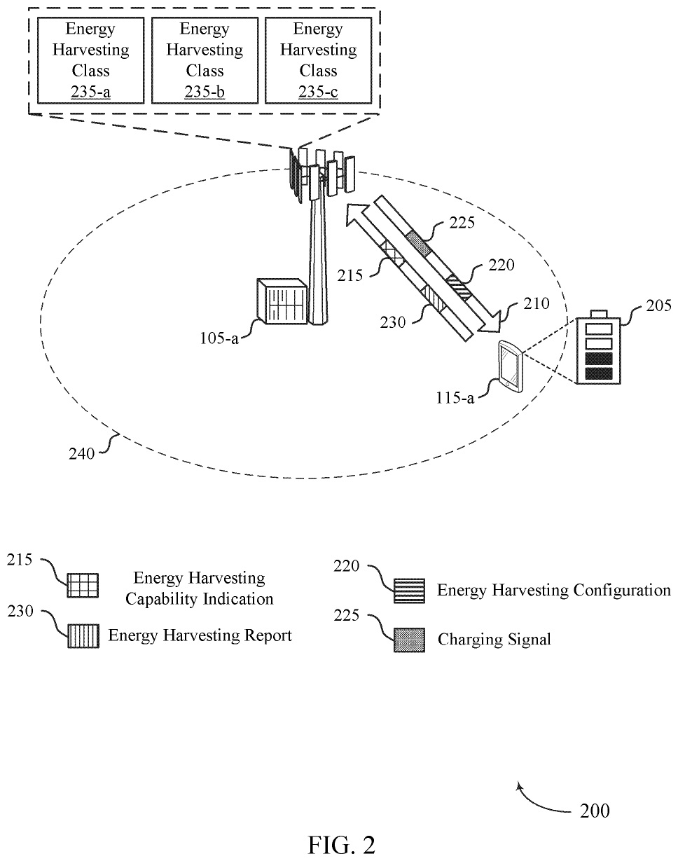

FIG. 2 illustrates an example of a wireless communications system 200 that supports radio frequency energy harvesting configuration in accordance with one or more aspects of the present disclosure. The wireless communications system 200 may implement or be implemented to realize aspects of the wireless communications system 100. For example, the wireless communications system 200 may illustrate communications between a UE 115-a and a network entity 105-a, which may be examples of corresponding devices described herein, including with reference to FIG. 1. Further, the UE 115-a and the network entity 105-a may communicate messages or signals using communication links 210, which may be examples of a communication link 125 described herein, with reference to FIG. 1.

The UE 115-a and the network entity 105-a may support performing energy harvesting procedures and processes (e.g., using dedicated energy harvesting resources) according to an energy harvesting capability of the UE 115-a. For example, the UE 115-a may signal (e.g., report) the energy harvesting capability (e.g., or an indication of the capability) in the energy harvesting capability indication 215 to the network entity 105-a. In some examples, the energy harvesting capability indication 215 may indicate a relationship between one or more energy harvesting parameters (e.g., of a charging signal 225) such as input power, frequency, waveform, modulation, or other parameters, and a threshold efficiency (e.g., a minimum efficiency) of an energy harvesting circuit of the UE 115-a. The energy harvesting capability indication 215 may include one or more relationships corresponding to one or more bandwidths, BWP, bandwidth combination, carrier frequency, or a combination thereof. In some cases, the UE 115-a may report the energy harvesting capability indication 215 after a change in frequency or bandwidth of a charging signal 225. In these cases, the UE 115-a may signal a difference (e.g., delta) of efficiency of the energy harvesting circuit due to the change in the charging signal 225 (e.g., frequency, BWP, carrier, bandwidth, bandwidth combination, or a combination thereof) in the energy harvesting capability indication 215.

In some cases, a UE 115-a may be associated with more than one energy harvesting capability. For example, the UE 115-a may be equipped (e.g., configured) with more than one energy harvesting circuit. The UE 115-a may report one or more of the energy harvesting capabilities in an energy harvesting capability indication 215 to the network entity 105-a. For example, the UE 115-a may report multiple efficiency curves corresponding to one or more of the energy harvesting circuits. Additionally, or alternatively, the UE 115-a may report different energy harvesting parameters for each of the energy harvesting circuits. In some cases, the UE 115-a may indicate an energy harvesting capability corresponding to a selected energy harvesting circuit when the UE 115-a switches to using the selected energy harvesting circuit for energy harvesting.

In some examples, one or more energy harvesting classes 235 may be defined. The network entity be configured with the one or more energy harvesting classes, such as energy harvesting class 235-a, energy harvesting class 235-b, and energy harvesting class 235-c. An energy harvesting class 235 may be associated with a relationship between a threshold efficiency (e.g., a minimum efficiency for energy harvesting, or for an energy harvesting circuit of the UE 115-a) and various energy harvesting parameters (e.g., of a charging signal 225) such as input power, frequency, waveform, modulation, or other parameters. In some cases, an energy harvesting capability indication 215 may be or contain an indication of an energy harvesting class 235. For example, the UE 115-a may signal an energy harvesting capability indication 215 that indicates energy harvesting class 235-a to the network entity 105-a. The network entity 105-a may receive the energy harvesting capability indication 215 and determine a relationship between energy harvesting efficiency and the one or more parameters, for example, based on the energy harvesting class 235-a. In some examples, the UE 115-a may signal more than one energy harvesting class 235 in an energy harvesting capability indication 215. In some examples, the network entity 105-a may receive one or more energy harvesting classes 235 for different devices, such as receiving energy harvesting classes 235 for multiple different UEs 115 or types of UEs 115.

In some examples, the UE 115-a may report RF energy harvesting efficiencies of the UE 115-a, or energy harvesting circuits of the UE 115-a, with respect to energy harvesting class. For example, the UE 115-a may indicate a class of the UE 115-a or a class of an energy harvesting circuit at the UE 115-a, and the network entity 105-a may determine the efficiency for the energy harvesting circuit or the UE 115-a based on the indicated class. In some cases, if an energy harvesting class is not defined, the UE 115-a may report a per bandwidth part, per band, or per band combination efficiency and input relationship. For example, if the network entity 105-a does not have an energy harvesting class 235 defined, and therefore does not have a corresponding efficiency curve for the energy harvesting class 235, the UE 115-a may report the characteristics of the efficiency curve to the network entity 105-a. In some examples, the UE 115-a may report efficiency curves or classes per band, per band combination, per carrier frequency, or any combination thereof. In some cases, the UE 115-a may report the efficiency curves or energy harvesting classes after a frequency change (e.g., changing between communicating in Frequency Range 1 and communicating in Frequency Range 2) or after a band change.

In some cases, the UE 115-a may indicate a change to an efficiency or an efficiency curve. For example, if the UE 115-a switches from communicating on a first band to a second band, and the network entity 105-a has an efficiency curve for the first band, the UE 115-a may report a change between the efficiency curve for the first band and an efficiency curve for the second band. This may reduce an overhead for reporting the efficiency curve for the second band.

In some cases, the network entity 105-a may transmit control signaling to the UE 115-a indicating an energy harvesting configuration 220 to the UE 115-a. The energy harvesting configuration 220 may be or contain a resource allocation for dedicated energy harvesting resources (e.g., resources in which a signal is beamformed to the UE 115-a to support energy harvesting), such as a radio frequency spectrum band corresponding to a charging signal 225. For example, the energy harvesting configuration 220 may contain an indication of a bandwidth, BWP, bandwidth combination, or carrier frequency corresponding to the charging signal 225. In some examples, the energy harvesting configuration 220 may indicate a periodicity or slot configuration for the charging signal 225. The network entity 105-a may select and transmit (e.g., according to the dedicated energy harvesting resources) a charging signal 225 to the UE 115-a for use in energy harvesting based on the energy harvesting configuration 220. In some examples, the charging signal 225 may be based on the energy harvesting capability indication 215 received from the UE 115-a.

The UE 115-a may adjust energy harvesting circuits (e.g., modify the way circuits are activated or connected), which may include antennas, rectifier circuits, and other components, in response to a received energy harvesting configuration 220. For example, one or more rectifier circuits may be mapped to one or more antennas of the UE 115-a. The UE 115-a may have antennas and rectifier circuits associated with specific frequency ranges, and the UE 115-a may modify, activate, or deactivate some energy harvesting circuits (e.g., through activating one or more power splitters) based on a frequency range received in an energy harvesting configuration 220. Different frequency configurations or bands used for energy harvesting techniques and signaling may affect how energy harvesting circuits at the UE 115-a are activated, connected, or operate. Therefore, the UE 115-a and the network entity 105-a may support signaling to indicate an energy signal configuration or frequency configuration for the energy harvesting signaling. For example, the UE 115-a may, in some cases, be indicated a configuration for the signaling such that the configuration for the energy harvesting signaling is known at the UE 115-a instead of assuming a configuration for the signaling.

In some examples, the network entity 105-a may support energy harvesting procedures for charging devices within an energy harvesting range 240. The network entity 105-a may report an indication of the energy harvesting range 240 to the UE 115-a (e.g., in an energy harvesting configuration 220). The energy harvesting range 240 may correspond to a distance of which the network entity 105-a can support RF charging to a UE 115-a using dedicated resources. If a UE 115 is not within the energy harvesting range 240, the UE 115-a may not be able to receive charging from the energy harvesting techniques on the dedicated resources.

Additionally, or alternatively, the network entity 105-a may transmit an indication to the UE 115-a of whether the UE 115-a is within the energy harvesting range 240. In some examples, the network entity 105-a or the UE 115-a, or both, may estimate a distance between the UE 115-a and the network entity 105-a based on one or more reference signals (e.g., demodulation reference signals, sounding reference signals, channel state information reference signals, other reference signals, or a combination thereof), filtering, or on an estimate received from a device. In some cases, the energy harvesting range 240 may be smaller than a range for the network entity to engage in wireless communications with devices such as UE 115-a. In some cases, the network entity 105-a may not assign resources dedicated for energy harvesting techniques to a UE 115 which is not within a charging rate distance.

In some examples, the UE 115-a may determine whether the UE 115-a is within the energy harvesting range 240 based on the indication from the network entity 105-a (e.g., received in the energy harvesting configuration 220). For example, the UE 115-a may determine that the UE 115-a is located outside the energy harvesting range 240 and rely on other technologies (e.g., Wi-fi, Bluetooth, or other technologies) or bands (e.g., industrial, scientific, and medical (ISM) bands, or other bands) for energy harvesting or signaling. In some cases, the UE 115 may determine whether to connect to the network entity 105-a based on whether the UE 115 is within the energy harvesting range 240, or the UE 115 may determine to use another technology or band (e.g., Wi-Fi, Bluetooth, or ISM bands). Additionally, or alternatively, the UE 115-a may determine whether the UE 115-a is within the energy harvesting range 240 based on determining the distance between the UE 115-a and the network entity 105-a (e.g., using the one or more reference signals or filtering).

In some cases, the network entity 105-a may transmit an explicit indication to the UE 115-a to indicate whether or not the UE 115-a is within the energy harvesting range 240 or the charging distance. In some cases, the network entity 105-a may indicate which UE classes are supported (e.g., for allocation of beamformed resources for energy transfer or energy harvesting) within different distances. For example, the network entity 105-a may indicate that a first class of UE 115 is supported for energy harvesting techniques within a first distance from the network entity 105-a (e.g., corresponding to a first energy harvesting range), and a second class of UE 115 is supported for energy harvesting techniques within a second distance from the network entity 105-a (e.g., corresponding to a second energy harvesting range). In some cases, the network entity 105-a may indicate which UE classes are supported during some time, which UE classes are supported until a some or an indicated duration, or which UE classes are supported currently or at time of indication, or any combination thereof. The indication may be transferred from the network entity 105-a to the UEs 115 using Layer 1, Layer 2, or Layer 3 signaling (e.g., L1, L2, or L3).

In some examples, the UE 115-a may report a maximum battery capacity of a battery 205 of the UE 115-a. The battery 205 of the UE 115-a may be an example of a capacitor (e.g., a super capacitor) or another device used as an energy source for the UE 115-a. The UE 115-a may report the maximum battery capacity used by the UE 115-a to the network entity 105-a in an energy harvesting capability indication 215. Additionally, or alternatively, an energy harvesting class 235 of the UE 115-a may be associated with a maximum battery capacity, so that the network entity 105-a may determine the maximum battery capacity from an indication of an energy harvesting class 235 (e.g., in an energy harvesting capability indication 215). The network entity 105-a may determine to stop charging the UE 115-a (e.g., by stopping transmission of the charging signal 225) based on the maximum battery capacity. In some cases, the UE 115-a may indicate an energy loss (e.g., power degradation or energy leakage) of the battery 205 in the energy harvesting capability indication 215. The network entity 105-a may determine a time for powering the UE 115-a (e.g., by transmitting a charging signal 225) based on the indication of energy loss. In some cases, the network entity 105-a may determine to charge the UE 115-a if the amount of energy loss at the UE 115-a is large (e.g., above a threshold amount).

In some cases, the UE 115-a may transmit an energy harvesting report 230 (e.g., to the network entity 105-a) indicating an energy harvesting status of the UE 115-a. For example, the UE 115-a may transmit an energy harvesting report 230 indicating the current charging rate of the UE 115-a. The UE 115-a may report the charging rate in energy or power units per a defined time unit (e.g., a slot, second, frame, or other unit). For example, the UE 115-a may report a charging rate in milliwatts, energy units per slot, milliwatts per slot, or another unit. In some cases, a UE 115-a may be able to perform energy harvesting using more than one energy resource. In these cases, the UE 115-a may report a charging rate for each energy resource. For example, the UE 115-a may transmit an energy harvesting report 230 for each energy resource (e.g., for each energy resource identifier), and the UE 115-a may include the corresponding energy resource identifier for each energy resource reported in the energy harvesting report 230. Additionally, or alternatively, the UE 115-a may transmit an energy harvesting report 230 corresponding to a set of energy resources and may report the charging rate for the set of energy resources. The network entity 105-a may determine when to stop transmitting the charging signal 225 to the UE 115-a based on the received charging rate.

In some cases, the UE 115-a may transmit the energy harvesting report 230 indicating a charging rate and an expected time duration for the UE 115-a, or the battery 205 of the UE 115-a, to be charged (e.g., to capacity or to a threshold amount). For example, the UE 115-a may report an expected time duration corresponding to a time duration to charge the battery 205 to a threshold amount or percentage. Additionally, or alternatively, the UE 115-a may report an expected time duration corresponding to a time duration to achieve a communication state (e.g., a state or charge level where the UE 115-a can start communication). In some cases, the UE 115-a may signal a requested increase (e.g., boost) in charging rate to achieve a maximum battery capacity or a communication state in the energy harvesting report 230. In some cases, the requested increase in charging rate may be a single-bit indication, where one bit state may indicate that the UE 115-a is satisfied with the current charging state, and the other bit state may indicate that the UE 115-a is requesting an increase in charging rate.

The network entity 105-a may determine when to stop transmitting the charging signal 225 to the UE 115-a based on the report. For example, the network entity 105-a may stop transmission of the charging signal 225 after a time duration indicated by the UE 115-a elapses (e.g., representing a time for the UE 115-a to complete charging), or after a next charging resource is transmitted. For example, the UE 115-a may indicate to stop transmitting the charging signal to the UE 115-a after a certain time duration (e.g., a quantity of seconds) or after a certain quantity of following charging resources. By reporting the battery level or charge level of the UE 115-a or the battery 205 of the UE 115-a, the network entity 105-a can allocate energy resources efficiently. For example, if the network entity 105-a knows the battery 205 at the UE 115-a is full or filled to a threshold charge, the network entity 105-a may avoid sending energy to the UE 115-a. Additionally, or alternatively, the network entity 105-a may determine to increase the charging rate (e.g., by increasing power, changing a resource for the charging signal 225, or another method) based on the report from the UE 115-a.

In some examples, the UE 115-a may transmit an energy harvesting report 230 (e.g., to the network entity 105-a) based on an event or trigger. In some cases, the UE 115-a may transmit an energy harvesting report 230 to the network entity 105-a based on an energy status (e.g., of the battery 205) or a change in a resource (e.g., source) used for energy harvesting. For example, the UE 115-a may transmit an energy harvesting report 230 to indicate rapid discharging when the UE 115-a detects a battery level dropping below a threshold capacity within a defined time. In some cases, the UE 115-a may transmit an energy harvesting report 230 signaling full battery capacity (e.g., a stop charging signal) if the UE 115-a determines the battery 205 is charged to capacity.

In some additional examples, the UE 115-a may transmit an energy harvesting report 230 if the battery level is above a first threshold capacity or below a second threshold capacity. For example, the UE 115-a may transmit the energy harvesting report 230 if the battery is more than a first percentage full or less than a second percentage full, or both. The threshold capacities described herein may be configured for the UE 115-a (e.g., preconfigured, or configured by the network entity 105-a) and may be a fraction or a percentage of the maximum battery capacity. In some cases, the thresholds (e.g., percentages) to trigger transmission of the energy harvesting report 230 may be configured, such as via control signaling, or preconfigured.

In some examples, the UE 115-a may transmit an energy harvesting report 230 indicating a switch in a band (e.g., a radio frequency spectrum band) being used to perform energy harvesting. The UE 115-a may transmit the energy harvesting report 230 in a previous band or on a new band that the UE 115-a selects for the switch. For example, the UE 115-a may be triggered to perform event-based energy harvesting reporting may be based on a change in one or more of a change in band, BWP, component carrier, frequency range, or any combination thereof, where the UE 115-a may transmit a report on a previous band, BWP, component carrier, frequency range, or any combination thereof, before switching or on new band, BWP, component carrier, frequency range, or any combination thereof.

In some examples, the UE 115-a may use bands from various technologies (e.g., Wi-Fi, Bluetooth, LTE, NR, or other technologies) for energy harvesting. In some cases, there may be a time duration for the UE 115-a to switch between a band for a technology being used for energy harvesting and a band used for communications with the network entity 105-a. The UE 115-a may signal the time duration to the network entity 105-a, for example, in the energy harvesting report 230 or the energy harvesting capability indication 215. In some cases, the UE 115-a may update the time duration, for example, in an energy harvesting report 230 to the network entity 105-a, as the UE 115-a switches from using one technology for energy harvesting to using another technology. For example, if the UE 115-a is using a radio frequency spectrum band to perform energy harvesting, data signaling from the network (e.g., via the network entity 105-a) may respect, or schedule around, a time constraint to switch between circuits, radio access technologies, or to be engaged in or disengage from RF energy harvesting.

In some cases, a UE 115 may be capable of storing or holding energy or charge, such as using a battery or an energy storage unit such as the battery 205. In some examples, if a UE 115 can hold energy (e.g., is capable of holding energy), the UE 115 may maintain a same battery unit, battery level, energy unit, energy level, energy storage unit, or power state, or another power component, value, or parameter (e.g., of a battery, charge unit, or storage unit such as the battery 205), until time to perform an action, such as continuing reading from a tag, writing to a tag, sending information to tag, or any combination thereof. In some cases, the UE 115 may experience energy loss (e.g., energy degradation or energy leakage) of the stored energy and may signal an amount of energy loss to a network entity 105.

In some cases, an energy harvesting class 235 (e.g., a type) of UE 115 may correspond to the energy loss. For example, the network entity 105 or the UE 115, or both, may determine the energy loss based on the energy harvesting class 235 or type of the UE 115. In some cases, the energy loss, energy degradation, or energy leakage may be based on specifications of the battery 205 or energy storage unit of the UE 115. In some cases, the energy harvesting class 235 of the UE 115 may correspond to one or more types of energy storage units or types of batteries, which may have corresponding known energy degradation or energy leakage rates. Additionally or alternatively, the UE 115 may determine the energy loss, for example, based on a capability of the UE 115 to determine or measure a current energy loss or energy leakage, and the UE 115 may signal the energy loss or energy leakage to the network entity 105.

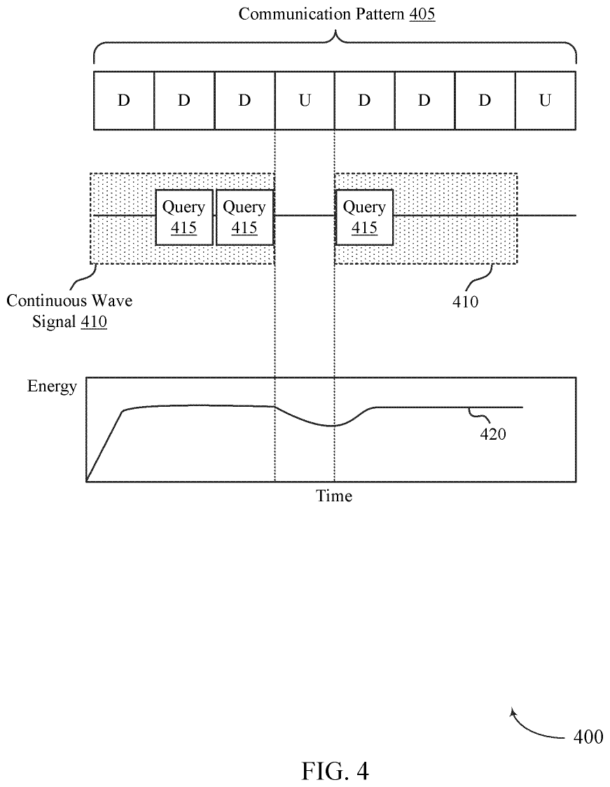

In some cases, the UE 115-a may be an example of an RF identification (RFID) tag. The UE 115-a may be capable of being read (e.g., by the network entity 105-b) even when the charging signal 225 is absent due to stored energy at the UE 115-a. In accordance with examples as disclosed herein, the UE 115-a may signal to the network entity 105-a (e.g., in the energy harvesting capability indication 215) an indication of a duration for the UE 115-a to be able to store energy and still transmit a signal during a read operation. For example, the UE 115-a may signal the duration as a quantity of time slots that the UE 115-a may be able to hold energy without receiving a charging signal 225. As such, the UE 115-a may still be able to transmit a signal during a read operation (e.g., at an energy cost to the battery 205). In some cases, the network entity 105-a may determine the duration based on an indication of an energy harvesting class 235. For example, the UE 115-a may send an indication of the energy harvesting class 235 (e.g., in an energy harvesting capability indication) at the beginning of a command sent or read from the UE 115-a. As described in more detail in FIG. 4, the network entity 105-a may determine a TDD pattern for communicating with the UE 115-a, for example, based on an indication of the duration from the UE 115-a.

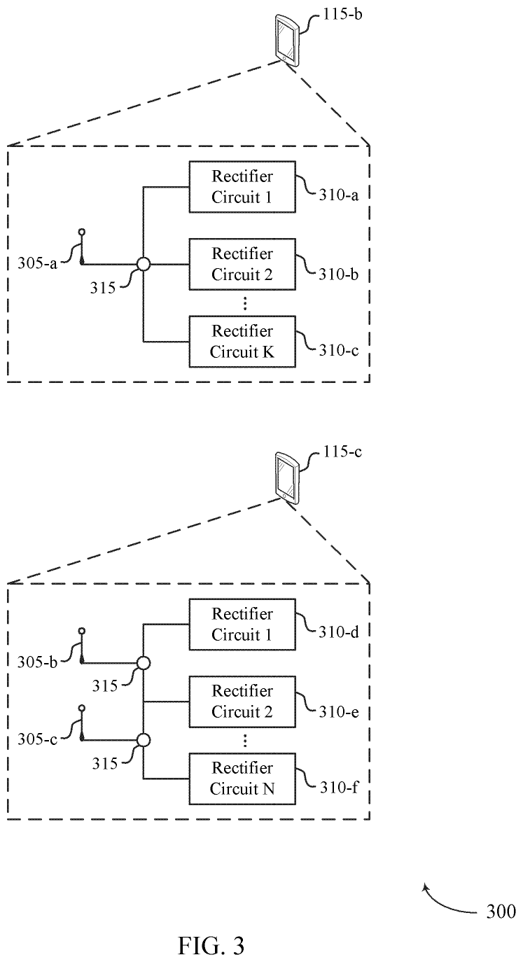

FIG. 3 illustrates an example of a configuration diagram 300 that supports radio frequency energy harvesting configuration in accordance with one or more aspects of the present disclosure. The configuration diagram 300 may implement or be implemented to realize aspects of the wireless communications system 200 or the wireless communications system 100. For example, the configuration diagram 300 illustrates example configurations for components of a UE 115-b and a UE 115-c, which may be examples of corresponding devices described herein, including with reference to FIGS. 1 and 2.

The UE 115-b and the UE 115-c may contain one or more antennas 305 that may be connected to one or more rectifier circuits 310, for example, via power splitters 315. For example, UE 115-b may contain an antenna 305-a connected to a quantity of K rectifier circuits 310. In an example, the antenna 305-a may be connected to rectifier circuits 310-a, 310-b and 310-c. Similarly, UE 115-c may contain antennas 305-b and 305-c connected to a number or quantity of N rectifier circuits 310, such as rectifier circuits 310-d, 310-e, and 310-f.

The UEs 115-b and 115-c may select one or more rectifier circuits 310 to connect to one or more antennas 305 (e.g., via power splitters 315) for radio frequency energy harvesting. For example, each rectifier circuit 310 may be associated with a central frequency and bandwidth range. Therefore, to operate the rectifier circuit 310, the UE 115 may be configured with a frequency configuration for a charging signal for energy harvesting, such that the UE 115 can select a rectifier circuit 310 which corresponds to the frequency configuration for the charging signal. In some cases, multiple rectifier circuits may be assigned to a same central frequency and bandwidth range or have a same number of stages. In some cases, a UE 115 may have multiple sets of one or more rectifier circuits 310 associated with different frequency or bandwidth range configurations. Additionally, or alternatively, the UE 115 may have one or more rectifier circuits 310 associated with different technologies that may be used for RF energy harvesting (e.g., Wi-Fi, Bluetooth, LTE, NR, or other technologies). In some examples, the UE 115 may adjust or select the rectifier circuits 310 based on a received configuration (e.g., from a network entity) indicating the frequency or band to be used for transmitting a charging signal. For example, based on an expected input power to the energy harvesting circuits, the UE 115 may select one or more rectifier circuits 310. The UE 115 may select the one or more rectifier circuits 310 with a certain quantity of stages, where a higher quantity of stages may be more efficient for a higher power range, or a lower quantity of stages may be more efficient for a lower power range.

In some examples, an energy harvesting class of the UE 115-b may be associated with one or more frequency configurations of the charging signal. In some examples, a network entity may select a frequency configuration based on the energy harvesting class of the UE 115. For example, the UE 115-b may signal an indication of the energy harvesting class of the UE 115-b, and the network entity may select a frequency configuration for the charging signal which can be efficiently used according to the energy harvesting class of the UE 115-b. In some cases, and the network entity may signal to the UE 115-b an indication of an ability to provide energy signals in a specific technology (e.g., LTE or NR) and one or more frequency or bandwidth range configurations for a charging signal to be transmitted. The UE 115-b may select one or more rectifier circuits 310 for receiving the charging signal during energy harvesting procedures based on the frequency or bandwidth range configuration received in the indication from the network entity.

In some cases, the UE 115-b may select one or more rectifier circuits 310 for use during energy harvesting procedures based on an input power of the charging signal. For example, the rectifier circuits 310 may contain varying number of stages within the circuit. A higher number of stages in a rectifier circuit 310-a may correspond to a higher efficiency in higher ranges of received power. Accordingly, the UE 115-b may select the rectifier circuit 310-a with a higher number of stages if it receives a high input power at the antenna 305-a or expects to receive a high input power (e.g., according to a received configuration, such as the frequency or bandwidth range configuration).

FIG. 4 illustrates an example of a signaling diagram 400 that supports radio frequency energy harvesting configuration in accordance with one or more aspects of the present disclosure. The signaling diagram 400 may implement or be implemented to realize aspects of the wireless communications system 200 or the configuration diagram 300. For example, the signaling diagram 400 illustrates a continuous wave signal 410 which may be an example of the charging signal 225 described herein, with reference to FIG. 2. Additionally, the signaling diagram 400 illustrates an example of an energy level 420, which may correspond to an energy level for a battery 205 or other power storage device of a UE as described herein.

In some examples, a UE may be an example of an RFID tag. An RFID tag may take time to power up (e.g. charge), then a network entity (e.g., a network entity 105 or an RF reader) may read data from the RFID tag or write (e.g., send data or commands) to the RFID tag. A read from the RFID tag may be performed using a continuous wave signal, which is then reflected or backscattered by the RFID tag with a payload. A write may be performed by sending a command or signal to the RFID tag through a modulated continuous wave signal.

In some examples, the UE may support holding energy without receiving a charging signal. For example, the UE may maintain a same energy level (e.g., energy state) or power state of a power component of the UE (e.g., an energy unit, energy storage unit, or another power component). In some cases, the UE may experience some energy loss (e.g., power loss, energy degradation, or energy leakage) while it holds energy. In some cases, a UE may hold energy if the UE can maintain energy to a certain state despite power loss, energy loss power degradation, energy leakage or energy degradation. For example, the UE may lose some charge or energy, but the UE may still be operable or in a communication state without receiving the charging signal, such as during an uplink slot, and the UE may report its energy holding capability to a network entity. Additionally, or alternatively, an energy harvesting class or a type of the UE may indicate the energy loss to the network entity. In some cases, the UE may determine the energy loss, for example, based on a capability of the UE to determine or measure a current energy loss or energy leakage, and the UE may signal the energy loss or energy leakage to the network entity.

In some cases, a network entity (e.g., RF source) transmitting the charging signal may determine a duration of time for powering up the UE based on a reported energy holding capability. For example, if the UE reports a large energy loss rate (e.g., due to power loss, energy loss, power degradation, energy degradation, or energy leakage), the network entity may determine how long to send the charging signal to charge the UE to a desired level. For example, a UE may lose an amount of energy equal to Pₗₒₛₛ*T, where Pₗₒₛₛ is a rate of energy loss, and T is a duration of time. If T is the time until the UE is sufficiently charged to perform an action (e.g., continue reading), the network entity (e.g., RF source) may determine a current state of energy or power relative to last energy or power state of the UE (e.g., passive IOT device) and may send a charging signal for at least the time duration T.

A network entity may read the UE (e.g., read a signal from the UE) in accordance with a communication pattern 405, which may be an example of a TDD pattern. For example, the network entity may transmit a continuous wave signal 410 to the UE. The continuous wave signal 410 may be used (e.g., by the network entity) to send a write operation or another command to the UE by transmitting during downlink (D) portions of the communication pattern 405. For example, the network entity or another device may transmit a query 415 on the continuous wave signal 410 to the UE during a downlink portion of the communication pattern 405, which may include a read request. The UE may backscatter a signal during an uplink (U) portion of the communication pattern 405, which may contain a payload (e.g., identification or authentication data, or other messages), and the network entity may read the backscattered signal. In some examples, by backscattering the signal during the uplink portion of the communication pattern 405, the UE may support transmission of signaling. For example, the UE may reflect or redirect, or both, at least a portion of the signal and include a payload of information in the reflected or redirected signal.

Some systems may utilize a time domain duplexing pattern of uplink and downlink slots. For example, an RFID tag may charge by receiving the continuous wave signal during downlink slots to perform energy harvesting. During one or more uplink slots, the RFID tag may at least partially discharge, and in some cases backscatter or transmit a response to a command or read query. In some cases, if the RFID tag discharges completely during the uplink slots, the RFID tag may recharge during a new downlink slot, where a network entity or another energy source may transmit the continuous wave signal to charge the RFID tag again. Some RFID tags may include a battery or charge storage unit, where the RFID tag can preserve energy for one or more uplink slots (or slots without the charging signal), which may prevent the RFID tag from completely discharging energy and powering up after the one or more uplink slots.

In some cases, a UE may indicate a capability to hold energy or maintain a charge during a time period (e.g., a slot) where the UE does not receive the charging signal. For example, the UE may indicate that the UE can maintain a charge using a battery or another charge storage unit. In some examples, the UE may signal to the network entity an indication of a duration that the UE is able to store energy and still transmit a signal during a read operation without receiving a charging signal. For example, the UE may indicate a capability to hold energy or maintain a charge for a certain duration until charging is resumed based on a time-domain slot pattern constraint. In some cases, the UE may indicate the duration as a quantity of time slots that the UE may be able to hold energy without receiving a charging signal 225 and still be able to transmit a signal during a read operation (e.g., at an energy cost to a battery or power storage component of the UE). For example, the UE may transmit an indication corresponding to a duration of one slot to the network entity.

In some cases, the UE may indicate an amount of energy loss (e.g., power loss, Pₗₒₛₛ). The network entity may determine a time to transmit the charging signal based on the amount of energy loss. For example, the network entity may determine a time duration that the UE is able to operate on a maintained charge and stop performing read operations after the time duration elapses. Additionally, the network entity may determine a current state of the battery (e.g., or charge storage unit) at a current time based on a time elapsed since a previous battery level (e.g., corresponding to a previous indication) and the indication of energy loss. For example, the network entity may use the equation Pₗₒₛₛ*T to find an amount of energy loss over an elapsed time T given an energy loss per unit time of Pₗₒₛₛ (e.g., indicated by the UE). The network entity may determine the current state of the charge of the UE based on the amount of energy loss. In some cases, the network entity may determine to charge the UE (e.g., determine a time to start transmitting the charging signal) based on the amount of energy loss (e.g., if the energy loss is large or above a threshold amount).

The network entity may determine one or more communication patterns 405 that may be used to communicate with or read the UE without the UE losing power based on the indication. For example, if the UE indicates a duration of one slot of a communication pattern 405, the network entity may determine that a DDUU communication pattern 405 may not be used, as the UE may not have the capability to hold enough energy for two uplink transmissions. In this example, the network entity may instead select a DDDU communication pattern 405, as illustrated in FIG. 4, for communication with the UE. In some cases, the network entity may determine to perform a read operation (e.g., a time to perform the operation) based on the duration of the UE for energy storage. In other examples, other UEs may be capable of storing different amounts of energy or be able to transmit for different quantities of uplink slots or support different communication patterns.

In some cases, the network entity may determine the duration during which the UE can hold energy for uplink transmissions based on an indication of an energy harvesting class corresponding to the UE. In some cases, the UE may send an indication of an energy harvesting class, for example, at the beginning of a command sent or read from the UE during an uplink portion of the communication pattern 405. For example, in the beginning of each command sent or read from tag, the tag may send its class (or the network entity may determine a class of the tag based on a tag identifier), then the network entity may assign resources accordingly for the tag. The network entity may determine a communication pattern 405 for communicating with the UE based on the indication. For example, the network entity may determine that the energy harvesting class of the UE is associated with a single slot duration capability for energy storage, and the network entity may select a communication pattern 405 accordingly.

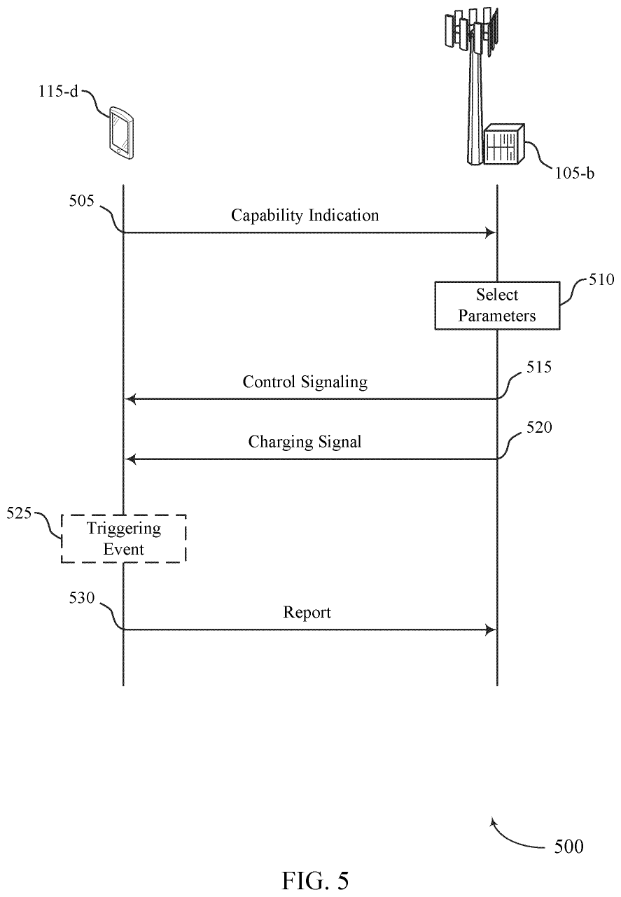

FIG. 5 illustrates an example of a process flow 500 that supports radio frequency energy harvesting configuration in accordance with one or more aspects of the present disclosure. The process flow 500 may implement or be implemented to realize aspects of the wireless communications systems 100 and 200, the configuration diagram 300, and the signaling diagram 400. For example, the process flow 500 illustrates communications between a UE 115-d and a network entity 105-b, which may be examples of corresponding devices described herein, including with reference to FIGS. 1-4.

At 505, the UE 115-d may transmit an indication of a capability to support RF energy harvesting to the network entity 105-b. The indication may be or include a relationship between various energy harvesting parameters of a charging signal, such as input power, frequency, waveform, modulation, or other parameters, and a threshold efficiency (e.g., a minimum efficiency of an energy harvesting circuit of the UE 115-d). In some examples, the indication may correspond to one or more bandwidths, BWP, bandwidth combination, carrier frequency, or a combination thereof. In some cases, the UE 115-d may transmit the indication after a change in frequency or bandwidth of a charging signal 225 (e.g., change from frequency range 1 (FR1) to frequency range 2 (FR2), or vice versa). In these cases, the UE 115-d may indicate a difference (e.g., delta) of efficiency of the energy harvesting circuit due to the change in the charging signal.

In some cases, the UE 115-d may transmit an indication of more than one energy harvesting capabilities. For example, the UE 115-a may be equipped (e.g., configured) with more than one energy harvesting circuits, which may be associated with different bandwidths, BWP, bandwidth combination, carrier frequency, RF technology, or a combination thereof. The UE 115-d may report one or more of the energy harvesting capabilities in the capability indication to the network entity 105-a. For example, the UE 115-d may report multiple efficiency curves corresponding to one or more of the energy harvesting circuits. Additionally, or alternatively, the UE 115-a may report different energy harvesting parameters for each of the energy harvesting circuits. In some cases, the UE 115-d may indicate an energy harvesting capability corresponding to a selected energy harvesting circuit when the UE 115-d switches to using the selected energy harvesting circuit for energy harvesting.

In some examples, the network entity 105-b be configured with one or more energy harvesting classes, which may correspond to types of UEs 115. An energy harvesting class may be associated with a relationship between a threshold efficiency (e.g., a minimum efficiency) for energy harvesting and various energy harvesting parameters (e.g., of a charging signal) such as input power, frequency, waveform, modulation, or other parameters. In some cases, the capability indication transmitted by the UE 115-d may be or contain an indication of an energy harvesting class. In some examples, the UE 115-a may signal more than one energy harvesting class 235 in an energy harvesting capability indication 215.

At 510, the network entity 105-b may determine or select parameters for energy harvesting procedures. For example, the network entity 105-b may determine an energy harvesting configuration including parameters for a charging signal, such as input power, frequency, waveform, modulation, or other parameters. The energy harvesting configuration may be based on the capability incitation received from the UE 115-d. For example, the network entity 105-b may receive the capability indication and determine a relationship between energy harvesting efficiency and the one or more parameters, in some cases, based on an energy harvesting class.

At 515, the network entity 105-b may transmit control signaling to the UE 115-d indicating the energy harvesting configuration. For example, the network entity 105-b may indicate a resource allocation for a radio frequency spectrum band corresponding to a charging signal. In some cases, the control signaling may include an indication of a coverage range of the signal for the energy harvesting. Additionally, or alternatively, the control signaling may include an indication that a position of the UE 115-d is within the coverage range of the signal. In some examples, the network entity 105-b may transmit the control signaling (e.g., or other data signals) after a switching duration for the UE 115-d to switch from receiving a signal for radio frequency energy harvesting to a band for receiving data transmissions.

At 520, the network entity 105-b may transmit a charging signal to the UE 115-d. The charging signal may be transmitted on a radio frequency spectrum band corresponding to the energy harvesting configuration. One or more components of the UE 115-d, such as a battery, a super capacitor, or other components, may be charged using the charging signal according to energy harvesting procedures.

At 525, the UE 115-d may determine that a trigger for transmitting an energy harvesting report. The trigger may correspond to a battery level for the UE 115-d, a change to the battery level for the battery, a change to a radio frequency spectrum band of the signal for radio frequency energy harvesting, or a combination thereof. In some examples, the triggering event may be based on the battery level of the UE 115-dsatisfying, exceeding, or dropping below a threshold (e.g., a configured threshold).

At 530, the UE 115-d may send an energy harvesting report to the network entity 105-b, for example, in response to detecting the trigger. For example, the UE 115-d may indicate the network entity 105-b of a battery level of the UE 115-d. The network entity 105-b may adjust energy harvesting parameters based on the report. For example, the network entity 105-b may stop transmission of a charging signal if the battery level of the UE 115-d is indicated to be at capacity, or the network entity 105-bmay increase the input power of the charging signal if the UE 115-d indicates that the battery level is low or rapidly discharging. In some cases, the UE 115-d may indicate a switch in a radio frequency spectrum band for energy harvesting or for communication. In these cases, the report may be transmitted in a previous band, or the new band selected for the switch. The network entity 105-b may change the charging signal according to the indication of the switch.

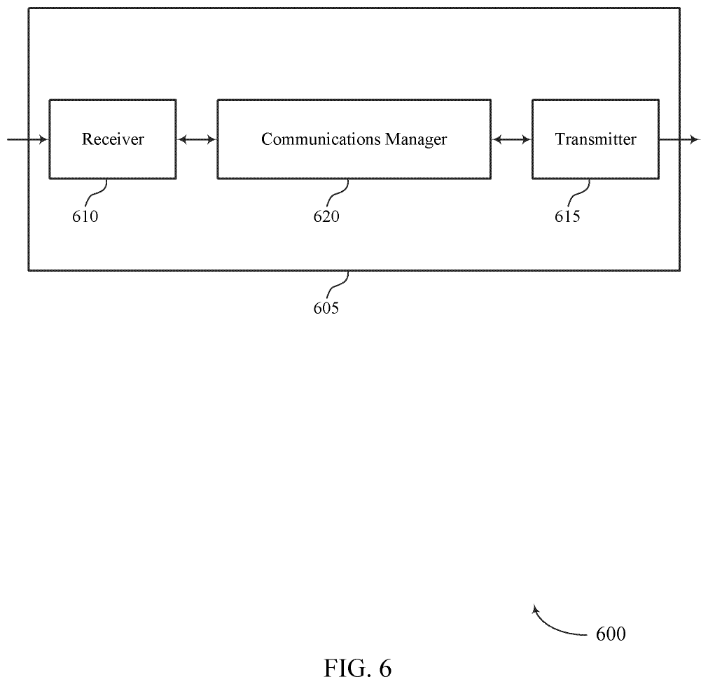

FIG. 6 shows a block diagram 600 of a device 605 that supports radio frequency energy harvesting configuration in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to radio frequency energy harvesting configuration). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to radio frequency energy harvesting configuration). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of radio frequency energy harvesting configuration as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software) executed by a processor. If implemented in code executed by a processor, the functions of the communications manager 620, the receiver 610, the transmitter 615, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. For example, the communications manager 620 may be configured as or otherwise support a means for transmitting an indication of a capability to support radio frequency energy harvesting at the UE. The communications manager 620 may be configured as or otherwise support a means for receiving control signaling indicating an energy harvesting configuration based on the indication of the capability. The communications manager 620 may be configured as or otherwise support a means for receiving, on a radio frequency spectrum band, a signal for the radio frequency energy harvesting to charge the UE based on the energy harvesting configuration. The communications manager 620 may be configured as or otherwise support a means for transmitting an energy harvesting report based on the energy harvesting configuration.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for more efficient communications, charging through energy harvesting procedures, and utilization of resources.

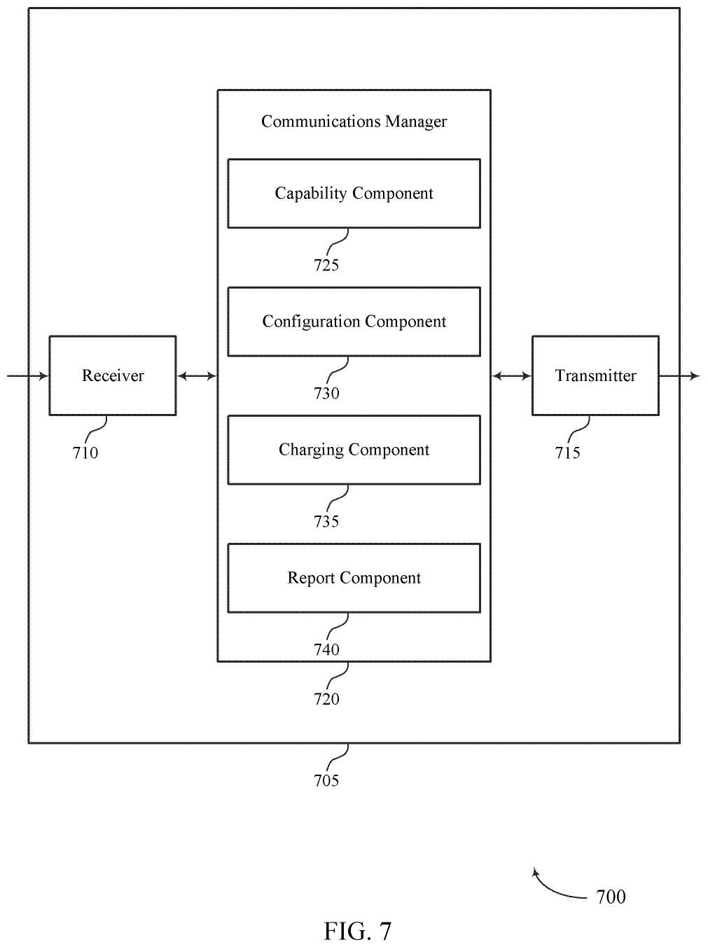

FIG. 7 shows a block diagram 700 of a device 705 that supports radio frequency energy harvesting configuration in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to radio frequency energy harvesting configuration). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to radio frequency energy harvesting configuration). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of radio frequency energy harvesting configuration as described herein. For example, the communications manager 720 may include a capability component 725, a configuration component 730, a charging component 735, a report component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. The capability component 725 may be configured as or otherwise support a means for transmitting an indication of a capability to support radio frequency energy harvesting at the UE. The configuration component 730 may be configured as or otherwise support a means for receiving control signaling indicating an energy harvesting configuration based on the indication of the capability. The charging component 735 may be configured as or otherwise support a means for receiving, on a radio frequency spectrum band, a signal for the radio frequency energy harvesting to charge the UE based on the energy harvesting configuration. The report component 740 may be configured as or otherwise support a means for transmitting an energy harvesting report based on the energy harvesting configuration.

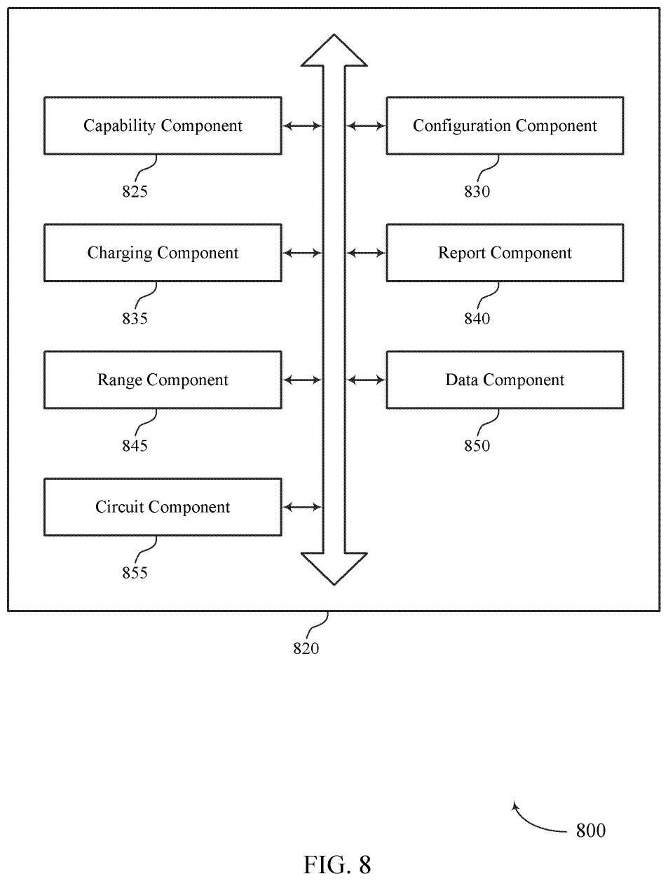

FIG. 8 shows a block diagram 800 of a communications manager 820 that supports radio frequency energy harvesting configuration in accordance with one or more aspects of the present disclosure. The communications manager 820 may be an example of aspects of a communications manager 620, a communications manager 720, or both, as described herein. The communications manager 820, or various components thereof, may be an example of means for performing various aspects of radio frequency energy harvesting configuration as described herein. For example, the communications manager 820 may include a capability component 825, a configuration component 830, a charging component 835, a report component 840, a range component 845, a data component 850, a circuit component 855, or any combination thereof. Each of these components may communicate, directly or indirectly, with one another (e.g., via one or more buses).

The communications manager 820 may support wireless communications at a UE in accordance with examples as disclosed herein. The capability component 825 may be configured as or otherwise support a means for transmitting an indication of a capability to support radio frequency energy harvesting at the UE. The configuration component 830 may be configured as or otherwise support a means for receiving control signaling indicating an energy harvesting configuration based on the indication of the capability. The charging component 835 may be configured as or otherwise support a means for receiving, on a radio frequency spectrum band, a signal for the radio frequency energy harvesting to charge the UE based on the energy harvesting configuration. The report component 840 may be configured as or otherwise support a means for transmitting an energy harvesting report based on the energy harvesting configuration.

In some examples, to support receiving the control signaling, the configuration component 830 may be configured as or otherwise support a means for receiving the control signaling indicating a resource allocation for the radio frequency spectrum band.

In some examples, to support transmitting the indication of the capability, the capability component 825 may be configured as or otherwise support a means for transmitting an indication of a charging storage capacity of the UE, where the signal for the radio frequency energy harvesting is received for a duration that is based on the charging storage capacity of the UE.

In some examples, to support transmitting the energy harvesting report, the report component 840 may be configured as or otherwise support a means for transmitting an indication that a battery of the UE satisfies a charge threshold based on receiving the signal for the radio frequency energy harvesting.

In some examples, to support transmitting the energy harvesting report, the report component 840 may be configured as or otherwise support a means for transmitting the energy harvesting report based on detecting a trigger to transmit the energy harvesting report corresponding to a battery level for a battery of the UE, a change to the battery level for the battery, a change to a radio frequency spectrum band of the signal for the radio frequency energy harvesting, or any combination thereof.

In some examples, the report component 840 may be configured as or otherwise support a means for reselecting to a second radio frequency spectrum band to receive the signal for the radio frequency energy harvesting, where energy harvesting report is transmitted on the radio frequency spectrum band or the second radio frequency spectrum band.

In some examples, to support transmitting the energy harvesting report, the report component 840 may be configured as or otherwise support a means for transmitting an indication of a charging rate for a battery of the UE based on the radio frequency energy harvesting, a duration until the battery is charged at least a threshold amount, a duration until the battery is charged to support communication, a requested charging rate, or any combination thereof.

In some examples, to support receiving the control signaling, the range component 845 may be configured as or otherwise support a means for receiving an indication of a coverage range of the signal for the radio frequency energy harvesting.

In some examples, the range component 845 may be configured as or otherwise support a means for receiving an indication that a position of the UE is within the coverage range of the signal, where the signal is received based on the indication that the position of the UE is within the coverage range of the signal.

In some examples, the range component 845 may be configured as or otherwise support a means for receiving a reference signal to determine a position of the UE is within the coverage range of the signal. In some examples, the range component 845 may be configured as or otherwise support a means for transmitting an indication that the position of the UE is within the coverage range of the signal, where the signal is received based on the indication that the position of the UE is within the coverage range of the signal.

In some examples, the range component 845 may be configured as or otherwise support a means for receiving an indication of one or more classes of UEs that are supported for the radio frequency energy harvesting within the coverage range of the signal, that are supported during a time duration, that are supported until an indicated time, that are supported at a current time, or any combination thereof.

In some examples, to support transmitting the indication of the capability, the capability component 825 may be configured as or otherwise support a means for transmitting an indication of a relationship between an output of an energy harvesting circuit of the UE and an input power to the energy harvesting circuit, a frequency of the signal for the radio frequency energy harvesting, a waveform of the signal for the radio frequency energy harvesting, a modulation of the signal for the radio frequency energy harvesting, or any combination thereof.

In some examples, the data component 850 may be configured as or otherwise support a means for monitoring for a data signal on the radio frequency spectrum band after a switching duration between the signal for the radio frequency energy harvesting and the data signal.

In some examples, the circuit component 855 may be configured as or otherwise support a means for selecting a corresponding one or more antenna elements to be connected to each of one or more selected rectifier circuits for the radio frequency energy harvesting based on an input power from the signal. In some examples, a first set of one or more rectifier circuits is associated with a first frequency configuration of a set of frequency configurations, and a second set of one or more rectifier circuits is associated with a second frequency configuration of the set of frequency configurations. In some examples, the one or more rectifier circuits are selected based on a radio access technology of the signal or the radio frequency spectrum band, or both.

In some examples, to support transmitting the indication of the capability, the capability component 825 may be configured as or otherwise support a means for transmitting an indication of a capability for the UE to hold energy based on the radio frequency energy harvesting.

In some examples, to support transmitting the indication of the capability, the capability component 825 may be configured as or otherwise support a means for transmitting an indication of a class of the UE, where the class of the UE indicates whether the UE is capable of holding energy. In some examples, the energy harvesting report includes an indication of a class of the UE.

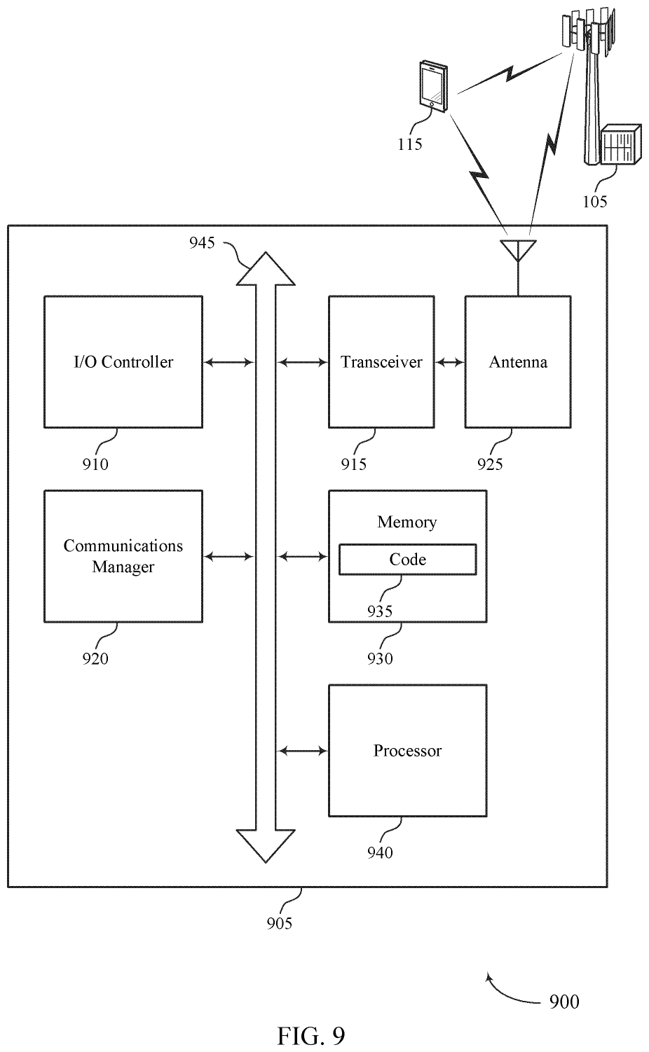

FIG. 9 shows a diagram of a system 900 including a device 905 that supports radio frequency energy harvesting configuration in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting radio frequency energy harvesting configuration). For example, the device 905 or a component of the device 905 may include a processor 940 and memory 930 coupled with or to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for transmitting an indication of a capability to support radio frequency energy harvesting at the UE. The communications manager 920 may be configured as or otherwise support a means for receiving control signaling indicating an energy harvesting configuration based on the indication of the capability. The communications manager 920 may be configured as or otherwise support a means for receiving, on a radio frequency spectrum band, a signal for the radio frequency energy harvesting to charge the UE based on the energy harvesting configuration. The communications manager 920 may be configured as or otherwise support a means for transmitting an energy harvesting report based on the energy harvesting configuration.

By including or configuring the communications manager 920 in accordance with examples as described herein, the device 905 may support techniques for more efficient communications, charging through energy harvesting procedures, and utilization of resources.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of radio frequency energy harvesting configuration as described herein, or the processor 940 and the memory 930 may be otherwise configured to perform or support such operations.

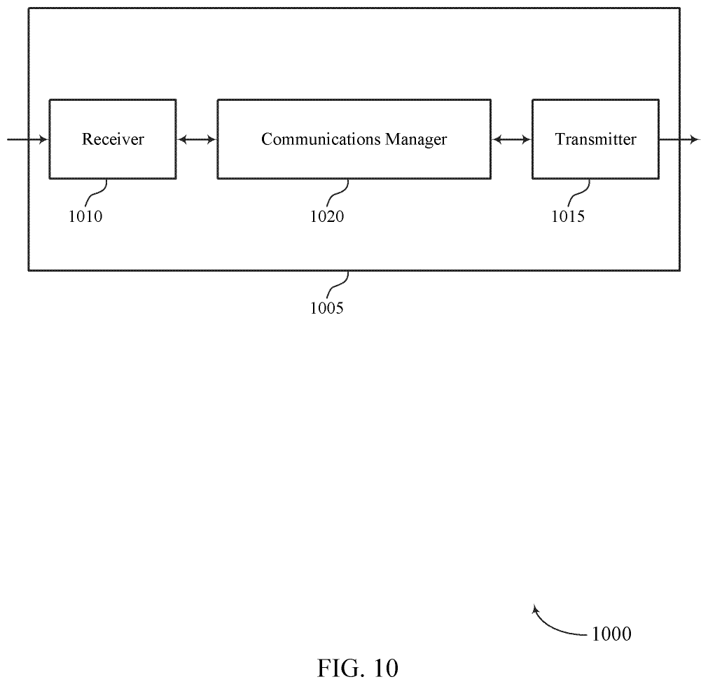

FIG. 10 shows a block diagram 1000 of a device 1005 that supports radio frequency energy harvesting configuration in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of radio frequency energy harvesting configuration as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software) executed by a processor. If implemented in code executed by a processor, the functions of the communications manager 1020, the receiver 1010, the transmitter 1015, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. For example, the communications manager 1020 may be configured as or otherwise support a means for receiving an indication of a capability for a UE to support radio frequency energy harvesting at the UE. The communications manager 1020 may be configured as or otherwise support a means for transmitting control signaling indicating an energy harvesting configuration based on the capability. The communications manager 1020 may be configured as or otherwise support a means for transmitting, on a radio frequency spectrum band, a signal for the radio frequency energy harvesting to charge the UE based on the energy harvesting configuration. The communications manager 1020 may be configured as or otherwise support a means for receiving an energy harvesting report based on the energy harvesting configuration.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for more efficient communications, charging through energy harvesting procedures, and utilization of resources.

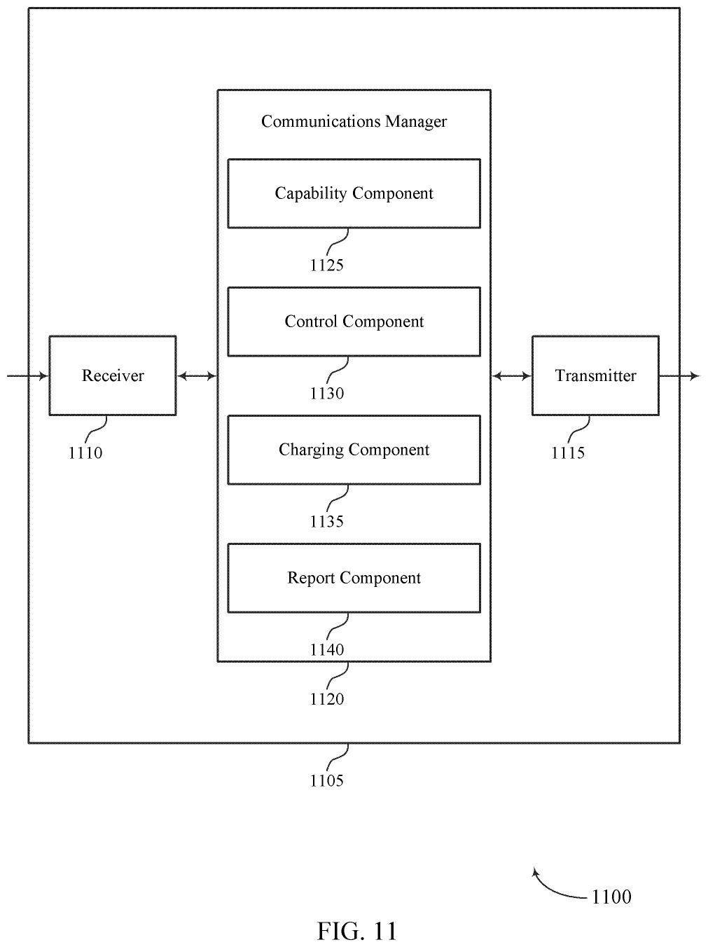

FIG. 11 shows a block diagram 1100 of a device 1105 that supports radio frequency energy harvesting configuration in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of radio frequency energy harvesting configuration as described herein. For example, the communications manager 1120 may include a capability component 1125, a control component 1130, a charging component 1135, a report component 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. The capability component 1125 may be configured as or otherwise support a means for receiving an indication of a capability for a UE to support radio frequency energy harvesting at the UE. The control component 1130 may be configured as or otherwise support a means for transmitting control signaling indicating an energy harvesting configuration based on the capability. The charging component 1135 may be configured as or otherwise support a means for transmitting, on a radio frequency spectrum band, a signal for the radio frequency energy harvesting to charge the UE based on the energy harvesting configuration. The report component 1140 may be configured as or otherwise support a means for receiving an energy harvesting report based on the energy harvesting configuration.

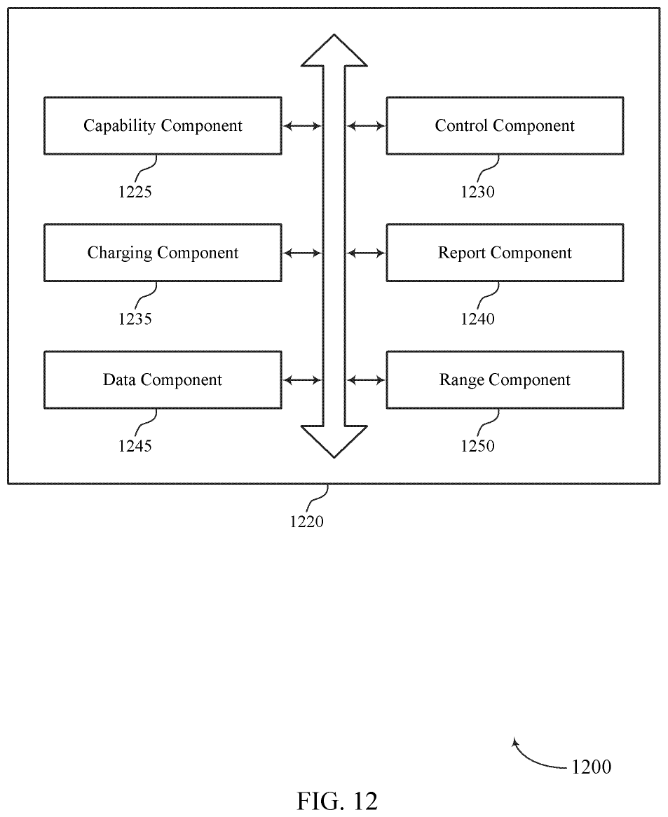

FIG. 12 shows a block diagram 1200 of a communications manager 1220 that supports radio frequency energy harvesting configuration in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of radio frequency energy harvesting configuration as described herein. For example, the communications manager 1220 may include a capability component 1225, a control component 1230, a charging component 1235, a report component 1240, a data component 1245, a range component 1250, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network entity in accordance with examples as disclosed herein. The capability component 1225 may be configured as or otherwise support a means for receiving an indication of a capability for a UE to support radio frequency energy harvesting at the UE. The control component 1230 may be configured as or otherwise support a means for transmitting control signaling indicating an energy harvesting configuration based on the capability. The charging component 1235 may be configured as or otherwise support a means for transmitting, on a radio frequency spectrum band, a signal for the radio frequency energy harvesting to charge the UE based on the energy harvesting configuration. The report component 1240 may be configured as or otherwise support a means for receiving an energy harvesting report based on the energy harvesting configuration.

In some examples, to support transmitting the control signaling, the control component 1230 may be configured as or otherwise support a means for transmitting the control signaling indicating a resource allocation for the radio frequency spectrum band.

In some examples, to support receiving the indication of the capability, the capability component 1225 may be configured as or otherwise support a means for receiving an indication of a charging storage capacity of the UE, where the signal for the radio frequency energy harvesting is received for a duration that is based on the charging storage capacity of the UE.

In some examples, to support receiving the energy harvesting report, the report component 1240 may be configured as or otherwise support a means for receiving an indication that a battery of the UE satisfies a charge threshold based on receiving the signal for the radio frequency energy harvesting.

In some examples, to support receiving the energy harvesting report, the report component 1240 may be configured as or otherwise support a means for receiving an indication of a charging rate for a battery of the UE based on the radio frequency energy harvesting, a duration until the battery is charged at least a threshold amount, a duration until the battery is charged to support communication, a requested charging rate, or any combination thereof.

In some examples, to support transmitting the control signaling, the control component 1230 may be configured as or otherwise support a means for transmitting an indication of a coverage range of the signal for the radio frequency energy harvesting.

In some examples, the range component 1250 may be configured as or otherwise support a means for transmitting or receiving an indication that a position of the UE is within the coverage range of the signal, where the signal is transmitted based on the indication that the position of the UE is within the coverage range of the signal.

In some examples, to support receiving the indication of the capability, the capability component 1225 may be configured as or otherwise support a means for receiving an indication of a relationship between an output of an energy harvesting circuit of the UE and an input power to the energy harvesting circuit, a frequency of the signal for the radio frequency energy harvesting, a waveform of the signal for the radio frequency energy harvesting, a modulation of the signal for the radio frequency energy harvesting, or any combination thereof.

In some examples, the data component 1245 may be configured as or otherwise support a means for transmitting a data signal on the radio frequency spectrum band after a switching duration between the signal for the radio frequency energy harvesting and the data signal.

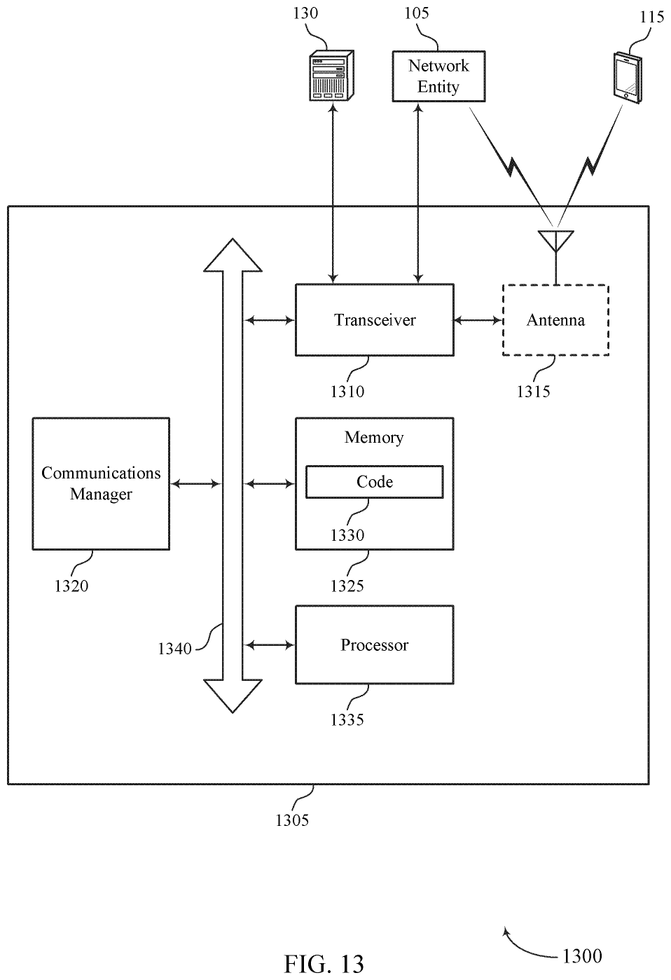

FIG. 13 shows a diagram of a system 1300 including a device 1305 that supports radio frequency energy harvesting configuration in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting radio frequency energy harvesting configuration). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-a wireless communications network technology to provide communication between network entities 105.

The communications manager 1320 may support wireless communications at a network entity in accordance with examples as disclosed herein. For example, the communications manager 1320 may be configured as or otherwise support a means for receiving an indication of a capability for a UE to support radio frequency energy harvesting at the UE. The communications manager 1320 may be configured as or otherwise support a means for transmitting control signaling indicating an energy harvesting configuration based on the capability. The communications manager 1320 may be configured as or otherwise support a means for transmitting, on a radio frequency spectrum band, a signal for the radio frequency energy harvesting to charge the UE based on the energy harvesting configuration. The communications manager 1320 may be configured as or otherwise support a means for receiving an energy harvesting report based on the energy harvesting configuration.

By including or configuring the communications manager 1320 in accordance with examples as described herein, the device 1305 may support techniques for more efficient communications, charging through energy harvesting procedures, and utilization of resources.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of radio frequency energy harvesting configuration as described herein, or the processor 1335 and the memory 1325 may be otherwise configured to perform or support such operations.

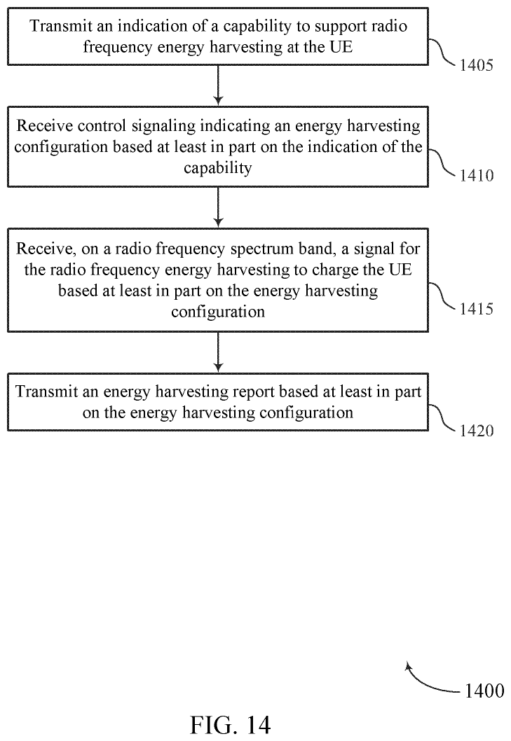

FIG. 14 shows a flowchart illustrating a method 1400 that supports radio frequency energy harvesting configuration in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting an indication of a capability to support radio frequency energy harvesting at the UE. The operations of 1405 may be performed in accordance with examples as disclosed herein. In some examples, aspects of the operations of 1405 may be performed by a capability component 825 as described with reference to FIG. 8.

At 1410, the method may include receiving control signaling indicating an energy harvesting configuration based on the indication of the capability. The operations of 1410 may be performed in accordance with examples as disclosed herein. In some examples, aspects of the operations of 1410 may be performed by a configuration component 830 as described with reference to FIG. 8.

At 1415, the method may include receiving, on a radio frequency spectrum band, a signal for the radio frequency energy harvesting to charge the UE based on the energy harvesting configuration. The operations of 1415 may be performed in accordance with examples as disclosed herein. In some examples, aspects of the operations of 1415 may be performed by a charging component 835 as described with reference to FIG. 8.

At 1420, the method may include transmitting an energy harvesting report based on the energy harvesting configuration. The operations of 1420 may be performed in accordance with examples as disclosed herein. In some examples, aspects of the operations of 1420 may be performed by a report component 840 as described with reference to FIG. 8.

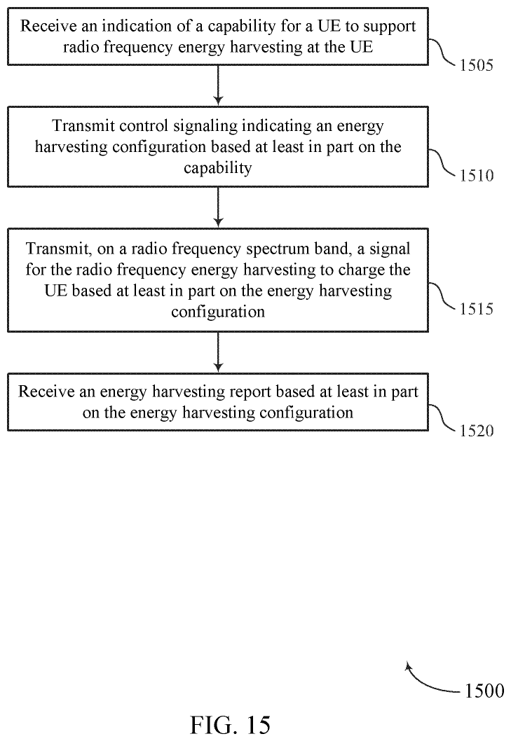

FIG. 15 shows a flowchart illustrating a method 1500 that supports radio frequency energy harvesting configuration in accordance with one or more aspects of the present disclosure. The operations of the method 1500 may be implemented by a network entity or its components as described herein. For example, the operations of the method 1500 may be performed by a network entity as described with reference to FIGS. 1 through 4 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include receiving an indication of a capability for a UE to support radio frequency energy harvesting at the UE. The operations of 1505 may be performed in accordance with examples as disclosed herein. In some examples, aspects of the operations of 1505 may be performed by a capability component 1225 as described with reference to FIG. 12.

At 1510, the method may include transmitting control signaling indicating an energy harvesting configuration based on the capability. The operations of 1510 may be performed in accordance with examples as disclosed herein. In some examples, aspects of the operations of 1510 may be performed by a control component 1230 as described with reference to FIG. 12.

At 1515, the method may include transmitting, on a radio frequency spectrum band, a signal for the radio frequency energy harvesting to charge the UE based on the energy harvesting configuration. The operations of 1515 may be performed in accordance with examples as disclosed herein. In some examples, aspects of the operations of 1515 may be performed by a charging component 1235 as described with reference to FIG. 12.

At 1520, the method may include receiving an energy harvesting report based on the energy harvesting configuration. The operations of 1520 may be performed in accordance with examples as disclosed herein. In some examples, aspects of the operations of 1520 may be performed by a report component 1240 as described with reference to FIG. 12.

The following provides an overview of aspects of the present disclosure:

Aspect 1: A method for wireless communications at a UE, comprising: transmitting an indication of a capability to support radio frequency energy harvesting at the UE; receiving control signaling indicating an energy harvesting configuration based at least in part on the indication of the capability: receiving, on a radio frequency spectrum band, a signal for the radio frequency energy harvesting to charge the UE based at least in part on the energy harvesting configuration; and transmitting an energy harvesting report based at least in part on the energy harvesting configuration.

Aspect 2: The method of aspect 1, wherein receiving the control signaling comprises: receiving the control signaling indicating a resource allocation for the radio frequency spectrum band.

Aspect 3: The method of any of aspects 1 through 2, wherein transmitting the indication of the capability comprises: transmitting an indication of a charging storage capacity of the UE, wherein the signal for the radio frequency energy harvesting is received for a duration that is based at least in part on the charging storage capacity of the UE.

Aspect 4: The method of any of aspects 1 through 3, wherein transmitting the energy harvesting report comprises: transmitting an indication that a battery of the UE satisfies a charge threshold based at least in part on receiving the signal for the radio frequency energy harvesting.

Aspect 5: The method of any of aspects 1 through 4, wherein transmitting the energy harvesting report comprises: transmitting the energy harvesting report based at least in part on detecting a trigger to transmit the energy harvesting report corresponding to a battery level for a battery of the UE, a change to the battery level for the battery, a change to a radio frequency spectrum band of the signal for the radio frequency energy harvesting, or any combination thereof.

Aspect 6: The method of any of aspects 1 through 5, further comprising: reselecting to a second radio frequency spectrum band to receive the signal for the radio frequency energy harvesting, wherein energy harvesting report is transmitted on the radio frequency spectrum band or the second radio frequency spectrum band.

Aspect 7: The method of any of aspects 1 through 6, wherein transmitting the energy harvesting report comprises: transmitting an indication of a charging rate for a battery of the UE based at least in part on the radio frequency energy harvesting, a duration until the battery is charged at least a threshold amount, a duration until the battery is charged to support communication, a requested charging rate, or any combination thereof.

Aspect 8: The method of any of aspects 1 through 7, wherein receiving the control signaling comprises: receiving an indication of a coverage range of the signal for the radio frequency energy harvesting.

Aspect 9: The method of aspect 8, further comprising: receiving an indication that a position of the UE is within the coverage range of the signal, wherein the signal is received based at least in part on the indication that the position of the UE is within the coverage range of the signal.

Aspect 10: The method of any of aspects 8 through 9, further comprising: receiving a reference signal to determine a position of the UE is within the coverage range of the signal: and transmitting an indication that the position of the UE is within the coverage range of the signal, wherein the signal is received based at least in part on the indication that the position of the UE is within the coverage range of the signal.

Aspect 11: The method of any of aspects 8 through 10, further comprising: receiving an indication of one or more classes of UEs that are supported for the radio frequency energy harvesting within the coverage range of the signal, that are supported during a time duration, that are supported until an indicated time, that are supported at a current time, or any combination thereof.

Aspect 12: The method of any of aspects 1 through 11, wherein transmitting the indication of the capability comprises: transmitting an indication of a relationship between an output of an energy harvesting circuit of the UE and an input power to the energy harvesting circuit, a frequency of the signal for the radio frequency energy harvesting, a waveform of the signal for the radio frequency energy harvesting, a modulation of the signal for the radio frequency energy harvesting, or any combination thereof.

Aspect 13: The method of any of aspects 1 through 12, further comprising: monitoring for a data signal on the radio frequency spectrum band after a switching duration between the signal for the radio frequency energy harvesting and the data signal.

Aspect 14: The method of any of aspects 1 through 13, further comprising: selecting one or more rectifier circuits for the radio frequency energy harvesting based at least in part on an input power from the signal.

Aspect 15: The method of aspect 14, wherein a first set of one or more rectifier circuits is associated with a first frequency configuration of a set of frequency configurations, and a second set of one or more rectifier circuits is associated with a second frequency configuration of the set of frequency configurations.

Aspect 16: The method of any of aspects 14 through 15, wherein the one or more rectifier circuits are selected based at least in part on a radio access technology of the signal or the radio frequency spectrum band, or both.

Aspect 17: The method of any of aspects 1 through 16, wherein transmitting the indication of the capability comprises: transmitting an indication of a capability for the UE to hold energy based at least in part on the radio frequency energy harvesting.

Aspect 18: The method of any of aspects 1 through 17, wherein transmitting the indication of the capability comprises: transmitting an indication of a class of the UE, wherein the class of the UE indicates whether the UE is capable of holding energy.

Aspect 19: The method of any of aspects 1 through 18, wherein the energy harvesting report includes an indication of a class of the UE.

Aspect 20: A method for wireless communications at a network entity, comprising: receiving an indication of a capability for a UE to support radio frequency energy harvesting at the UE: transmitting control signaling indicating an energy harvesting configuration based at least in part on the capability: transmitting, on a radio frequency spectrum band, a signal for the radio frequency energy harvesting to charge the UE based at least in part on the energy harvesting configuration; and receiving an energy harvesting report based at least in part on the energy harvesting configuration.

Aspect 21: The method of aspect 20, wherein transmitting the control signaling comprises: transmitting the control signaling indicating a resource allocation for the radio frequency spectrum band.

Aspect 22: The method of any of aspects 20 through 21, wherein receiving the indication of the capability comprises: receiving an indication of a charging storage capacity of the UE, wherein the signal for the radio frequency energy harvesting is received for a duration that is based at least in part on the charging storage capacity of the UE.

Aspect 23: The method of any of aspects 20 through 22, wherein receiving the energy harvesting report comprises: receiving an indication that a battery of the UE satisfies a charge threshold based at least in part on receiving the signal for the radio frequency energy harvesting.

Aspect 24: The method of any of aspects 20 through 23, wherein receiving the energy harvesting report comprises: receiving an indication of a charging rate for a battery of the UE based at least in part on the radio frequency energy harvesting, a duration until the battery is charged at least a threshold amount, a duration until the battery is charged to support communication, a requested charging rate, or any combination thereof.

Aspect 25: The method of any of aspects 20 through 24, wherein transmitting the control signaling comprises: transmitting an indication of a coverage range of the signal for the radio frequency energy harvesting.

Aspect 26: The method of aspect 25, further comprising: transmitting or receiving an indication that a position of the UE is within the coverage range of the signal, wherein the signal is transmitted based at least in part on the indication that the position of the UE is within the coverage range of the signal.

Aspect 27: The method of any of aspects 20 through 26, wherein receiving the indication of the capability comprises: receiving an indication of a relationship between an output of an energy harvesting circuit of the UE and an input power to the energy harvesting circuit, a frequency of the signal for the radio frequency energy harvesting, a waveform of the signal for the radio frequency energy harvesting, a modulation of the signal for the radio frequency energy harvesting, or any combination thereof.

Aspect 28: The method of any of aspects 20 through 27, further comprising: transmitting a data signal on the radio frequency spectrum band after a switching duration between the signal for the radio frequency energy harvesting and the data signal.

Aspect 29: An apparatus for wireless communications at a UE, comprising a processor: memory coupled with the processor; and instructions stored in the memory and executable by the processor to cause the apparatus to perform a method of any of aspects 1 through 19.

Aspect 30: An apparatus for wireless communications at a UE, comprising at least one means for performing a method of any of aspects 1 through 19.

Aspect 31: A non-transitory computer-readable medium storing code for wireless communications at a UE, the code comprising instructions executable by a processor to perform a method of any of aspects 1 through 19.

Aspect 32: An apparatus for wireless communications at a network entity, comprising a processor: memory coupled with the processor: and instructions stored in the memory and executable by the processor to cause the apparatus to perform a method of any of aspects 20 through 28.

Aspect 33: An apparatus for wireless communications at a network entity, comprising at least one means for performing a method of any of aspects 20 through 28.

Aspect 34: A non-transitory computer-readable medium storing code for wireless communications at a network entity, the code comprising instructions executable by a processor to perform a method of any of aspects 20 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-a, LTE-a Pro, or NR system may be described for purposes of example, and LTE, LTE-a, LTE-a Pro, or NR terminology may be used in much of the description, the techniques described herein are applicable beyond LTE, LTE-a, LTE-a Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, etc., whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM, phase change memory, or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
transmitting an indication of a capability to support radio frequency energy harvesting at the UE;
receiving control signaling indicating an energy harvesting configuration based at least in part on the indication of the capability;
receiving, on a radio frequency spectrum band, a signal for the radio frequency energy harvesting to charge the UE based at least in part on the energy harvesting configuration; and
transmitting an energy harvesting report based at least in part on the energy harvesting configuration.

2. The method of claim 1, wherein receiving the control signaling comprises:
receiving the control signaling indicating a resource allocation for the radio frequency spectrum band.

3. The method of claim 1, wherein transmitting the indication of the capability comprises:
transmitting an indication of a charging storage capacity of the UE, wherein the signal for the radio frequency energy harvesting is received for a duration that is based at least in part on the charging storage capacity of the UE.

4. The method of claim 1, wherein transmitting the energy harvesting report comprises:
transmitting an indication that a battery of the UE satisfies a charge threshold based at least in part on receiving the signal for the radio frequency energy harvesting.

5. The method of claim 1, wherein transmitting the energy harvesting report comprises:
transmitting the energy harvesting report based at least in part on detecting a trigger to transmit the energy harvesting report corresponding to a battery level for a battery of the UE, a change to the battery level for the battery, a change to a radio frequency spectrum band of the signal for the radio frequency energy harvesting, or any combination thereof.

6. The method of claim 1, further comprising:
reselecting to a second radio frequency spectrum band to receive the signal for the radio frequency energy harvesting, wherein energy harvesting report is transmitted on the radio frequency spectrum band or the second radio frequency spectrum band.

7. The method of claim 1, wherein transmitting the energy harvesting report comprises:
transmitting an indication of a charging rate for a battery of the UE based at least in part on the radio frequency energy harvesting, a duration until the battery is charged at least a threshold amount, a duration until the battery is charged to support communication, a requested charging rate, or any combination thereof.

8. The method of claim 1, wherein receiving the control signaling comprises:
receiving an indication of a coverage range of the signal for the radio frequency energy harvesting.

9. The method of claim 8, further comprising:
receiving an indication that a position of the UE is within the coverage range of the signal, wherein the signal is received based at least in part on the indication that the position of the UE is within the coverage range of the signal.

10. The method of claim 8, further comprising:
receiving a reference signal to determine a position of the UE is within the coverage range of the signal; and
transmitting an indication that the position of the UE is within the coverage range of the signal, wherein the signal is received based at least in part on the indication that the position of the UE is within the coverage range of the signal.

11. The method of claim 8, further comprising:
receiving an indication of one or more classes of UEs that are supported for the radio frequency energy harvesting within the coverage range of the signal, that are supported during a time duration, that are supported until an indicated time, that are supported at a current time, or any combination thereof.

12. The method of claim 1, wherein transmitting the indication of the capability comprises:
transmitting an indication of a relationship between an output of an energy harvesting circuit of the UE and an input power to the energy harvesting circuit, a frequency of the signal for the radio frequency energy harvesting, a waveform of the signal for the radio frequency energy harvesting, a modulation of the signal for the radio frequency energy harvesting, or any combination thereof.

13. The method of claim 1, further comprising:
monitoring for a data signal on the radio frequency spectrum band after a switching duration between the signal for the radio frequency energy harvesting and the data signal.

14. The method of claim 1, further comprising:
selecting a corresponding one or more antenna elements to be connected to each of one or more selected rectifier circuits for the radio frequency energy harvesting based at least in part on an input power from the signal.

15. The method of claim 14, wherein a first set of one or more rectifier circuits is associated with a first frequency configuration of a set of frequency configurations, and a second set of one or more rectifier circuits is associated with a second frequency configuration of the set of frequency configurations.

16. The method of claim 14, wherein the one or more rectifier circuits are selected based at least in part on a radio access technology of the signal or the radio frequency spectrum band, or both.

17. The method of claim 1, wherein transmitting the indication of the capability comprises:
transmitting an indication of a capability for the UE to hold energy based at least in part on the radio frequency energy harvesting.

18. The method of claim 1, wherein transmitting the indication of the capability comprises:
transmitting an indication of a class of the UE, wherein the class of the UE indicates whether the UE is capable of holding energy.

19. The method of claim 1, wherein the energy harvesting report includes an indication of a class of the UE.

20. A method for wireless communications at a network entity, comprising:
receiving an indication of a capability for a user equipment (UE) to support radio frequency energy harvesting at the UE;
transmitting control signaling indicating an energy harvesting configuration based at least in part on the capability;
transmitting, on a radio frequency spectrum band, a signal for the radio frequency energy harvesting to charge the UE based at least in part on the energy harvesting configuration; and
receiving an energy harvesting report based at least in part on the energy harvesting configuration.

21. The method of claim 20, wherein transmitting the control signaling comprises:
transmitting the control signaling indicating a resource allocation for the radio frequency spectrum band.

22. The method of claim 20, wherein receiving the indication of the capability comprises:
receiving an indication of a charging storage capacity of the UE, wherein the signal for the radio frequency energy harvesting is received for a duration that is based at least in part on the charging storage capacity of the UE.

23. The method of claim 20, wherein receiving the energy harvesting report comprises:
receiving an indication that a battery of the UE satisfies a charge threshold based at least in part on receiving the signal for the radio frequency energy harvesting.

24. The method of claim 20, wherein receiving the energy harvesting report comprises:
receiving an indication of a charging rate for a battery of the UE based at least in part on the radio frequency energy harvesting, a duration until the battery is charged at least a threshold amount, a duration until the battery is charged to support communication, a requested charging rate, or any combination thereof.

25. The method of claim 20, wherein transmitting the control signaling comprises:
transmitting an indication of a coverage range of the signal for the radio frequency energy harvesting.

26. The method of claim 25, further comprising:
transmitting or receiving an indication that a position of the UE is within the coverage range of the signal, wherein the signal is transmitted based at least in part on the indication that the position of the UE is within the coverage range of the signal.

27. The method of claim 20, wherein receiving the indication of the capability comprises:
receiving an indication of a relationship between an output of an energy harvesting circuit of the UE and an input power to the energy harvesting circuit, a frequency of the signal for the radio frequency energy harvesting, a waveform of the signal for the radio frequency energy harvesting, a modulation of the signal for the radio frequency energy harvesting, or any combination thereof.

28. The method of claim 20, further comprising:
transmitting a data signal on the radio frequency spectrum band after a switching duration between the signal for the radio frequency energy harvesting and the data signal.

29. An apparatus for wireless communications at a user equipment (UE), comprising:
at least one processor; and
memory coupled with the at least one processor, the memory storing instructions executable by the at least one processor to cause the UE to:
transmit an indication of a capability to support radio frequency energy harvesting at the UE;
receive control signaling indicating an energy harvesting configuration based at least in part on the indication of the capability;
receive, on a radio frequency spectrum band, a signal for the radio frequency energy harvesting to charge the UE based at least in part on the energy harvesting configuration; and
transmit an energy harvesting report based at least in part on the energy harvesting configuration.

30. An apparatus for wireless communications at a network entity, comprising:
at least one processor; and
memory coupled with the at least one processor, the memory storing instructions executable by the at least one processor to cause the network entity to:
receive an indication of a capability for a user equipment (UE) to support radio frequency energy harvesting at the UE;
transmit control signaling indicating an energy harvesting configuration based at least in part on the capability;
transmit, on a radio frequency spectrum band, a signal for the radio frequency energy harvesting to charge the UE based at least in part on the energy harvesting configuration; and
receive an energy harvesting report based at least in part on the energy harvesting configuration.
